(19) United States
(12) Patent Application Publication
(10) Pub. No.: US 2016/0313962 A1
(43) Pub. Date: Oct. 27, 2016

(54) METHOD AND ELECTRONIC DEVICE FOR DISPLAYING CONTENT

(71) Applicant: Samsung Electronics Co., Ltd., Suwon-si (KR)

(72) Inventors: Yong-Jin KWON, Suwon-si (KR); Jin-Un KIM, Suwon-si (KR); Jae-Sook JOO, Seongnam-si (KR)

(21) Appl. No.: 15/075,566

(22) Filed: Mar. 21, 2016

(30) Foreign Application Priority Data
Apr. 22, 2015 (KR) 10-2015-0056713

(51) Int. Cl. G06F 3/14; G06T 3/60; G06F 3/0488

(52) U.S. Cl. CPC G06F 3/1423; G06F 3/0488; G06T 3/60; G06T 2200/24

(57) ABSTRACT

A method and an electronic device for displaying content are provided. The method includes identifying a first content element corresponding to a preset virtual display among one or more content elements to be displayed on a display of the electronic device and displaying a first portion of the first content element on the display based on orientation information of the virtual display on the display.

### CROSS-REFERENCE TO RELATED APPLICATION(S)

This application claims the benefit under 35 U.S.C. §119(a) of a Korean patent application filed on Apr. 22, 2015 in the Korean Intellectual Property Office and assigned Serial number 10-2015-0056713, the entire disclosure of which is hereby incorporated by reference.

### TECHNICAL FIELD

The present disclosure relates to a method and an electronic device for displaying content. More particularly, the present disclosure relates to a method of displaying one or more content elements by an electronic device.

### BACKGROUND

Recently, electronic devices have been configured to provide a multi-display function using a plurality of displays. A multi-display function combines a display area of two or more displays to create a single display area where a user can interact with the content in the single display area using the two or more displays. In an electronic device implementing a multi-display function, content may be displayed within the entire display area or within a portion of the display area. Alternatively, when a plurality of content elements is provided within the display area, each content element may be individually displayed within the display area. When a content element is displayed within the entire display area, the content element spans the entire display area where a portion of the content element is displayed on a first display, and a portion of the content element is displayed on a second display, etc. When a content element is displayed within a portion of the display area, the content element spans less than the entire display area where the content element may be displayed within a single display or span two or more displays. When a first content element and a second content element are provided within the display area, the first content element and second content element can be displayed using one or more displays. In addition, a user may interact with the content element. For example, a content element displayed on one display may be selected, copied, expanded, and/or moved within the entire display area including another display in the multi-display system.

Further, a plurality of content elements may be displayed within a single display using a virtual display. A virtual display is a logical display mapped to a physical display of the device. For example, one use of a virtual display includes a picture in picture (PIP) function. The virtual display function may be implemented using hardware such as a plurality of tuners in a television (TV) or monitor. Alternatively, a second display may be simulated using software such as a development option by JELLY BEAN PLUS used by an ANDROID operating system (OS).

The above information is presented as background information only to assist with an understanding of the present disclosure. No determination has been made, and no assertion is made, as to whether any of the above might be applicable as prior art with regard to the present disclosure.

### SUMMARY

When display directions of a plurality of displays are different from each other, an electronic device supporting a multi-display system may have a limitation in providing a graphical user interface (GUI) for displaying content on the display. Further, the electronic device may have a limitation in processing touch inputs received through the plurality of displays as a multi-touch input.

Aspects of the present disclosure are to address at least the above-mentioned problems and/or disadvantages and to provide at least the advantages described below. Accordingly, an aspect of the present disclosure is to provide a method and an electronic device for displaying content to solve the above described problems or other problems.

In accordance with an aspect of the present disclosure, a method of displaying content by an electronic device is provided. The method includes identifying a first content element corresponding to a preset virtual display among one or more content elements to be displayed on a display of the electronic device and displaying a first portion of the first content element on the display based on orientation information of the virtual display on the display.

In accordance with another aspect of the present disclosure, an electronic device is provided. The electronic device includes a display that displays one or more content elements and a processor that identifies a first content element corresponding to a preset virtual display among the one or more content elements to be displayed on a display and displays a first portion of the first content element on the display based on orientation information of the virtual display on the display.

In accordance with another aspect of the present disclosure, an electronic device is provided. The electronic device includes a first display that displays a first content element based on a first orientation and a processor configured to display a first area of a second content element on the first display based on a second orientation and to display a second area of the second content element on a second display of another electronic device connected to the electronic device to configure a multi-display based on the second orientation, wherein the second display displays a third content element based on a third orientation.

According to various embodiments of the present disclosure, although display directions of a plurality of displays are different from each other, an electronic device may provide a GUI for properly displaying content on each of the plurality of displays.

Further, according to various embodiments of the present disclosure, the electronic device may process touch inputs received through the plurality of displays as a multi-touch input.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a network environment including an electronic device according to various embodiments of the present disclosure;

FIG. 2 is a block diagram of a programming module according to various embodiments of the present disclosure;

FIGS. 3A, 3B, 3C, 3D, and 3E illustrate a content display method according to a comparative example of various embodiments of the present disclosure;

FIGS. 4A, 4B, 4C, and 4D illustrate a method of recognizing a plurality of touch inputs according to a comparative example of various embodiments of the present disclosure;

FIG. 5 is a flowchart illustrating a content display method by an electronic device according to various embodiments of the present disclosure;

FIG. 6A is a block diagram of an electronic device according to various embodiments of the present disclosure;

FIG. 6B is a block diagram for describing information included in a memory of an electronic device according to various embodiments of the present disclosure;

FIG. 7 is a view for describing a state where a virtual screen is mapped by an electronic device according to various embodiments of the present disclosure;

FIGS. 8A and 8B are views for describing a method of displaying content through a virtual screen by an electronic device according to various embodiments of the present disclosure;

FIG. 9 is a flowchart illustrating a method of displaying a first portion of a first content element on a display by an electronic device according to various embodiments of the present disclosure;

FIG. 10 is a flowchart illustrating a method of displaying a first portion of a first content element on a display by an electronic device according to various embodiments of the present disclosure;

FIGS. 11A and 11B illustrate a method of displaying a plurality of content elements on a plurality of displays by an electronic device according to various embodiments of the present disclosure;

FIGS. 12A and 12B illustrate a method of displaying a plurality of content elements on a plurality of displays by an electronic device according to various embodiments of the present disclosure;

FIGS. 13A and 13B are flowcharts illustrating a method of recognizing a plurality of touch inputs by an electronic device according to various embodiments of the present disclosure;

FIGS. 14A, 14B, and 14C illustrate a method of recognizing a plurality of touch inputs by an electronic device according to various embodiments of the present disclosure;

FIG. 15 is a flowchart illustrating a method of displaying each of the one or more content elements on a display according to a Z-order by an electronic device according to various embodiments of the present disclosure;

FIGS. 16A, 16B, 16C, and 16D illustrate a method of displaying each of the one or more content elements on a display according to a Z-order by an electronic device according to various embodiments of the present disclosure;

FIGS. 17A, 17B, 17C, and 17D illustrate a method of displaying each of the one or more content elements on a display according to a Z-order by an electronic device according to various embodiments of the present disclosure;

FIGS. 18A and 18B illustrate mapping between a virtual display and a physical display by an electronic device according to various embodiments of the present disclosure;

FIG. 19 is a flowchart illustrating a content display method by an electronic device according to various embodiments of the present disclosure;

FIG. 20 is a flowchart illustrating a content display method by an electronic device according to various embodiments of the present disclosure; and

FIG. 21 is a block diagram of an electronic device according to various embodiments of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As used herein, the expression “have”, “may have”, “include”, or “may include” refers to the existence of a corresponding feature (e.g., numeral, function, operation, or constituent element such as component), and does not exclude one or more additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B.

The expression “a first”, “a second”, “the first”, or “the second” used in various embodiments of the present disclosure may modify various components regardless of the order and/or the importance but does not limit the corresponding components. For example, a first user device and a second user device indicate different user devices although both of them are user devices. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposer between them. In contrast, it may be understood that when an element (e.g., first element) is referred to as being “directly connected,” or “directly coupled” to another element (second element), there are no element (e.g., third element) interposed between them.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g. embedded processor) only for performing the corresponding operations or a generic-purpose processor (e.g., central processing unit (CPU) or application processor (AP)) that can perform the corresponding operations by executing one or more software programs stored in a memory device.

The terms used herein are merely for the purpose of describing particular embodiments of the present disclosure and are not intended to limit the scope of other embodiments. Unless defined otherwise, all terms used herein, including technical terms and scientific terms, may have the same meaning as commonly understood by a person of ordinary skill in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even the term defined in the present disclosure should not be interpreted to exclude various embodiments of the present disclosure.

An electronic device according to various embodiments of the present disclosure may include at least one of, for example, a smart phone, a tablet personal computer (PC), a mobile phone, a video phone, an electronic book reader (e-book reader), a desktop PC, a laptop PC, a netbook computer, a workstation, a server, a personal digital assistant (PDA), a portable multimedia player (PMP), a moving picture experts group phase 1 (MPEG-1) audio layer-3 (MP3) player, a mobile medical device, a camera, and a wearable device. According to various embodiments of the present disclosure, the wearable device may include at least one of an accessory type (e.g., a watch, a ring, a bracelet, an anklet, a necklace, a glasses, a contact lens, or a head-mounted device (HMD)), a fabric or clothing integrated type (e.g., an electronic clothing), a body-mounted type (e.g., a skin pad, or tattoo), and a bio-implantable type (e.g., an implantable circuit).

According to various embodiments of the present disclosure, the electronic device may be a home appliance. The home appliance may include at least one of, for example, a television (TV), a digital versatile disc (DVD) player, an audio, a refrigerator, an air conditioner, a vacuum cleaner, an oven, a microwave oven, a washing machine, an air cleaner, a set-top box, a home automation control panel, a security control panel, a TV box (e.g., SAMSUNG HOMESYNC, APPLE TV, or GOOGLE TV), a game console (e.g., XBOX and PLAYSTATION), an electronic dictionary, an electronic key, a camcorder, and an electronic photo frame.

According to an embodiment of the present disclosure, the electronic device may include at least one of various medical devices (e.g., various portable medical measuring devices (e.g., a blood glucose monitoring device, a heart rate monitoring device, a blood pressure measuring device, a body temperature measuring device, etc.), a magnetic resonance angiography (MRA), a magnetic resonance imaging (MRI), a computed tomography (CT) machine, and an ultrasonic machine), a navigation device, a global positioning system (GPS) receiver, an event data recorder (EDR) , a flight data recorder (FDR) , a vehicle infotainment devices, an electronic devices for a ship (e.g., a navigation device for a ship, and a gyro-compass), avionics, security devices, an automotive head unit, a robot for home or industry, an automatic teller machine (ATM) in banks, point of sales (POS) in a shop, or Internet device of things (e.g., a light bulb, various sensors, electric or gas meter, a sprinkler device, a fire alarm, a thermostat, a streetlamp, a toaster, a sporting goods, a hot water tank, a heater, a boiler, etc.).

According to various embodiments of the present disclosure, the electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device according to various embodiments of the present disclosure may be a combination of one or more of the aforementioned various devices. The electronic device according to various embodiments of the present disclosure may be a flexible device. Further, the electronic device according to an embodiment of the present disclosure is not limited to the aforementioned devices, and may include a new electronic device according to the development of technology.

Hereinafter, an electronic device according to various embodiments of the present disclosure will be described with reference to the accompanying drawings. As used herein, the term “user” may indicate a person who uses an electronic device or a device (e.g., an artificial intelligence electronic device) that uses an electronic device.

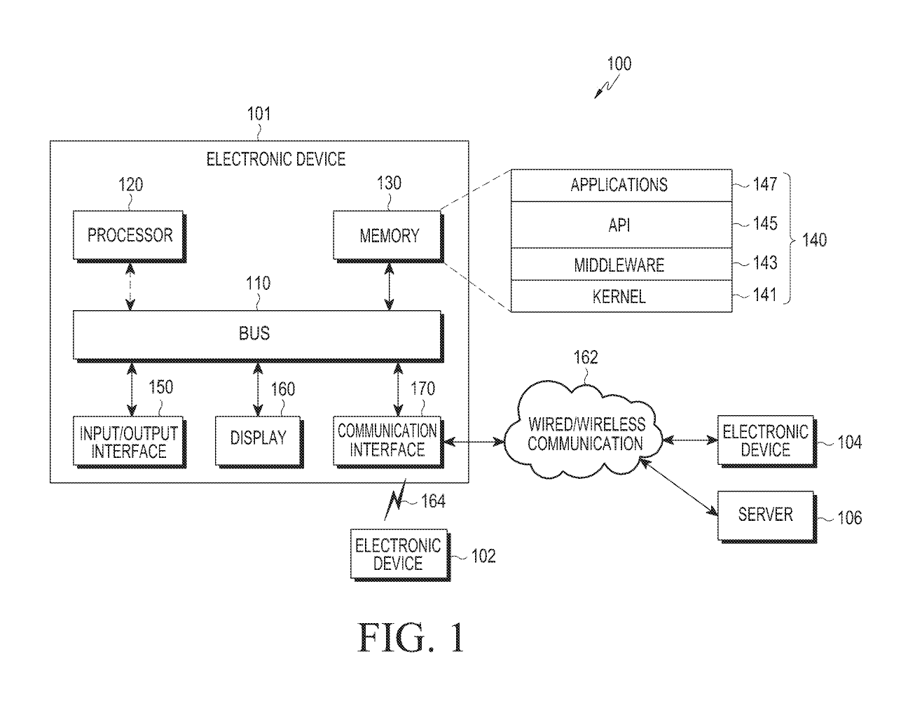

FIG. 1 illustrates a network environment including an electronic device according to various embodiments of the present disclosure.

Referring to FIG. 1, an electronic device 101 within a network environment 100 according to various embodiments of the present disclosure is described. The electronic device 101 may include a bus 110, a processor 120, a memory 130, an input/output interface 150, a display 160, and a communication interface 170. In various embodiments of the present disclosure, the electronic device 101 may omit at least one of the above components or further include other components.

The bus 110 may include, for example, a circuit for connecting the components 110 to 170 and transmitting communication (for example, control messages and/or data) between the components.

The processor 120 may include one or more of a CPU, an AP, and a communication processor (CP). For example, the processor 120 may control at least one other component of the electronic device 101 and/or carry out operations or data processing related to communication.

The memory 130 may include a volatile memory and/or a non-volatile memory. The memory 130 may store, for example, commands or data related to one or more other components of the electronic device 101. According to an embodiment, the memory 130 may store software and/or a program 140. The program 140 may include a kernel 141, middleware 143, an application programming interface (API) 145, and/or an application program (or “application”) 147. At least some of the kernel 141, the middleware 143, and the API 145 may be referred to as an operating system (OS).

The kernel 141 may control or manage system resources (for example, the bus 110, the processor 120, or the memory 130) used for executing an operation or function implemented by other programs (for example, the middleware 143, the API 145, or the application 147). Furthermore, the kernel 141 may provide an interface through which the middleware 143, the API 145, or the application programs 147 may access individual components of the electronic device 101 to control or manage system resources.

The middleware 143 may serve as, for example, an intermediary for allowing the API 145 or the application programs 147 to communicate with the kernel 141 to exchange data.

Further, the middleware 143 may process one or more task requests received from the application programs 147 according to priorities thereof. For example, the middleware 143 may assign priorities, by which system resources (for example, the bus 110, the processor 120, the memory 130 or the like) of the electronic device 101 can be first used, to at least one of the application programs 147. For example, the middleware 143 may perform scheduling or loading balancing on the one or more task requests by processing the one or more task requests according to the assigned priorities.

The API 145 is an interface by which the applications 147 control functions provided from the kernel 141 or the middleware 143, and may include, for example, at least one interface or function (for example, command) for file control, window control, image processing, or text control.

For example, the input/output interface 150 may serve as an interface that may transfer commands or data input from a user or another external device to other component(s) of the electronic device 101. Further, the input/output interface 150 may output commands or data received from other component(s) of the electronic device 101 to the user or another external device.

The display 160 may include, for example, a liquid crystal display (LCD), a light emitting diode (LED) display, an organic LED (OLED) display, a micro electro mechanical system (MEMS) display, or an electronic paper display. The display 160 may display various types of content (for example, text, images, videos, icons, symbols, etc.) for users. The display 160 may include a touch screen, and may receive, for example, a touch, gesture, proximity, or hovering made by using an electronic pen or a part of the user's body.

For example, the communication interface 170 may configure communication between the electronic device 101 and an external device (for example, a first external electronic device 102, a second external electronic device 104, or a server 106). For example, the communication interface 170 may be connected to a network 162 through wireless or wired communication to communicate with the external device (for example, the second external electronic device 104 or the server 106).

The wireless communication may use at least one of, for example, long term evolution (LTE), LTE-advanced (LTE-A), code division multiple access (CDMA), wideband CDMA (WCDMA), universal mobile telecommunications system (UMTS), wireless broadband (WiBro), and global system for mobile communications (GSM) as a cellular communication protocol. Further, the wireless communication may include, for example, short-range communication 164. The short-range communication 164 may include at least one of, for example, Wi-Fi, Bluetooth, near field communication (NFC), and global navigation satellite system (GNSS). The GNSS may include at least one of, for example, a GPS, a global navigation satellite system (GLONASS), a BeiDou navigation satellite system (BeiDou), and Galileo (European global satellite-based navigation system). Hereinafter, in the present disclosure, the “GPS” may be interchangeably used with the “GNSS”. The wired communication may include at least one of, for example, a universal serial bus (USB), a high definition multimedia interface (HDMI), recommended standard 232 (RS-232), and a plain old telephone service (POTS). The network 162 may include at least one of communication networks such as a computer network (for example, a local area network (LAN) or a wide area network (WAN)), the Internet, and a telephone network.

Each of the first and second external electronic devices 102 and 104 may be a device which is the same as or different from the electronic device 101. According to an embodiment of the present disclosure, the server 106 may include a group of one or more servers. According to various embodiments of the present disclosure, all or some of the operations performed by the electronic device 101 may be performed by another electronic device or a plurality of electronic devices (for example, the electronic device 102 or 104 or server 106). According to an embodiment of the present disclosure, when the electronic device 101 should perform some functions or services automatically or by a request, the electronic device 101 may make a request for performing at least some of the functions related to the functions or services to another device (for example, the electronic device 102 or 104 or the server 106) instead of performing the functions or services by itself. The other electronic device (for example, the electronic device 102 or 104, or the server 106) may carry out the requested functions or additional functions and provide results thereof to the electronic device 101. The electronic device 101 may provide requested functions or services based on the received results or after additionally processing the received results. To this end, for example, cloud computing, distributed computing, or client-server computing technology may be used.

The processor 120 may process at least some of the information obtained from other components (for example, at least one of the memory 130, the input/output interface 150, and the communication interface 170) and utilize the information in various manners. For example, the processor 120 may control at least some functions of the electronic device 101 so that the electronic device 101 may interwork with other electronic devices (for example, the electronic device 102 or 104 or the server 106). The processor 120 may be integrated with the communication interface 170. According to an embodiment of the present disclosure, at least one component of the processor 120 may be included in the server 160 and at least one operation implemented by the processor 120 may be supported by the server 106.

According to an embodiment of the present disclosure, the memory 130 may include instructions to operate the processor 120. For example, the memory 130 may include instructions for allowing the processor 120 to control other component of the electronic device 101 and to interwork with other electronic devices 102 and 104 or the server 106. The processor 120 may control other components of the electronic device 101 and interwork with other electronic devices 102 and 104 or the server 106 based on the instructions stored in the memory 130. Hereinafter, the operations of the electronic device 101 will be described based on the respective components of the electronic device 101. Further, the instructions for allowing the receptive components to perform the operations may be included in the memory 130.

The electronic device 101 according to various embodiments of the present disclosure may be connected to other electronic devices 102 and 104 to configure and execute a multi-display. As described above, the electronic device 101 may be connected to other electronic devices 102 and 104 through the short-range communication 164 or through the network 162. Further, the electronic device 101 may be connected to other electronic devices 102 and 104 through a wire.

The multi-display function may be a function that combines displays of a device using two or more displays and copies, expands, or individually outputs one or more content elements to the display screens. For example, the user may connect a PC to two or more monitors and copy, expand, or individually output one or more content elements to the screens of the two monitors. Similarly, electronic devices, each of which includes one display, may connect to each other to use the multi-display function such that the display area includes the display of each of the connected electronic devices. For example, electronic device 101 may be connected to other electronic devices 102 and 104 such that a content element displayed on the display 160 of the electronic device 101 may be copied, expanded, or individually output on one or more of the displays of the other electronic devices 102 and 104.

The display 160 according to various embodiments of the present disclosure may display one or more content elements. One or more content elements are may be displayed on the display 160 based on at least one of a user input, configuration information of an application, and configuration information of an operating system. The content elements may include an image or video data which can be displayed on the display and may be displayed on the display 160 through a window or interface.

The one or more elements may be selected, copied, expanded, or individually output on the display 160 and displays of other electronic devices 102 and 104. Further, the one or more content elements may be displayed on the corresponding displays, respectively. For example, when a first content element corresponds to a first display, the first content element may be displayed on the first display. When a second content element corresponds to a second display, the second content element may be displayed on the second display. Further, when a third content element corresponds to a virtual display, the third content element may be displayed on at least one of the first display and the second display according to mapping information between the virtual display and physical displays which correspond to the first display and the second display.

According to various embodiments of the present disclosure, the processor 120 may identify the first content element corresponding to a preset virtual display among one or more content elements to be displayed on the display 160. The virtual display may refer to a logical display mapped to a physical display which is the display 160. For example, the virtual display has no actual physical device to perform the display and may refer to a logical device including virtual display context. The display context corresponds to information indicating a display state and may include various pieces of information expressing a display state such as a width, a height, a density, and an orientation. As described above, due to inherent display context of the virtual display, the virtual display may have orientation information, size information, and density information, which are different from those of the physical display. Further, while the physical display has a limitation on changing the orientation information, the virtual display can change the orientation information without particular limitation.

In addition, through the virtual display, a separate algorithm may not be added to every application to display content elements to overlap the first display and the second display. For example, the virtual display allows the electronic device to display a content element over one or more content elements displayed on the first display and/or the second display without modifying currently existing applications such that any determination associated with displaying the content element over the one or more content elements displayed on the first display and/or the second display is performed separately from each application.

According to various embodiments of the present disclosure, the processor 120 may configure the virtual display by configuring state information such as context of the virtual display. For example, the state information of the virtual display may include at least one of the size, orientation information, and density of the virtual display. In addition, the state information of the virtual display may include various pieces of information expressing the state of the virtual display.

According to various embodiments of the present disclosure, the processor 120 may configure the state information of the virtual display based on a received input. Among various pieces of the state information of the virtual display, the state information, which is not configured based on the user input, may be predetermined. Further, the state information of the virtual display may be automatically configured by an operating system and/or an application.

According to various embodiments of the present disclosure, the communication interface 170 may transmit the state information of the virtual display to the other connected electronic devices 102 and 104 to configure or execute a multi-display function. Further, the electronic device 101 may receive state information of the virtual display configured by the other electronic devices 102 and 104 from the other electronic devices 102 and 104. Accordingly, the electronic device 101 and the other electronic devices 102 and 104 may share the preset state information of the virtual display. Further, by sharing the state information of the virtual display, the processor 120 may map the virtual display to each of the display 160 and the displays of the other electronic devices 102 and 104. Accordingly, content elements corresponding to the virtual display may be displayed over the display 160 and the displays of the other electronic devices 102 and 104.

According to various embodiments of the present disclosure, the processor 120 may display a first portion of the first content element on the display 160 based on orientation information of the virtual display on the display 160. For example, the processor 120 may display the first portion of the first content element based on an orientation corresponding to the orientation information of the virtual display on the display 160. A method of displaying the first portion of the first content element based on the orientation information of the virtual display on the display 160 by the processor 120 will be described below.

According to various embodiments of the present disclosure, the processor 120 may identify the first content element based on at least one of a user input, configuration information of the operating system, and configuration information of the application. For example, the processor 120 may identify the first content element based on content display configuration information of the operating system or content display configuration information of the application. The display corresponding to each of the one or more content elements may be determined or selected in advance. The processor 120 may identify the first content element by using information on the display corresponding to each of the one or more content elements.

According to various embodiments of the present disclosure, the processor 120 may select or determine the display corresponding to each of the one or more content elements based on at least one of a user input, configuration information of the operating system, and configuration information of the executed application. Further, a processor of the electronic device 102 or 104 may select or determine the display corresponding to each of the one or more content elements, and transmit information on the selection or determination to the electronic device 101.

According to various embodiments of the present disclosure, the processor 120 may display a first portion of the first content element by using mapping information between the display 160 and the virtual display. The processor 120 may display the first portion of the first content element on an area of the display 160 to which the virtual display is mapped.

When the entire virtual display is mapped to the display 160, the whole first content element may be displayed on the display 160. However, only a portion of the virtual display may be mapped to the display 160. For example, a first area of the virtual display may be mapped to the display 160 and a second area of the virtual display may be mapped to the displays of the electronic devices 102 and 104. In this case, the entire first content element may not be displayed on the display 160. The first portion of the first content element corresponding to the first area of the virtual display may be displayed on the display 160 and the second portion of the first content element corresponding to the second area of the virtual display may be displayed on the displays of the electronic devices 102 and/or 104. As described above, when only a portion of the virtual display is mapped to the display 160, the first content element may be divided and displayed on the display 160 and the displays of the electronic devices 102 and 104.

According to various embodiments of the present disclosure, the mapping information may be generated based on state information of the display 160 and state information of the virtual display. As described above, the size of the virtual display such as the width and height may be configured during a configuration operation. The processor 120 may generate the mapping information between the display and the virtual display by using the size of the virtual display. Further, when a display location of the virtual display is configured during the configuration operation, the processor 120 may use the display location for generating the mapping information. When the display location is not configured, the display location may be configured by default.

According to various embodiments of the present disclosure, when the state information of the virtual display is updated based on at least one of the received user input, a change in the content display configuration information of the operating system, and a change in the content display configuration information of the application, the processor 120 may update the orientation information and the mapping information between the display and the virtual display. As described above, by updating the orientation information and the mapping information, the processor 120 may display the first content element on the display 160 and the displays of the electronic devices 102 and 104 in accordance with the change in the state information of the virtual display.

According to various embodiments of the present disclosure, the processor 120 may display a first portion of the first content element on the display 160 based on orientation information of the virtual display on the display 160. Further, the processor 120 may display first portion of the first content element on the display 160 such that the first portion is rotated. The following description will be made based on an assumption that the orientation information of the virtual display and the orientation information of the display 160 are different from each other. When the first portion of the first content element is displayed on the display 160 without rotation, the first portion may be displayed to correspond to the orientation of the display 160. Accordingly, since the first portion corresponding to the virtual display may be displayed based on an undesired orientation, the first portion may be rotated to correspond to the orientation information of the virtual display. The orientation information may be configured according to each display and changed according to at least one of the user input, configuration information of the application, and configuration information of the operating system.

According to various embodiments of the present disclosure, the processor 120 may convert coordinate information of a received first touch input to correspond to the orientation information of the virtual display one the display 160. The first touch input may correspond to the virtual display. The first touch input is received through a touch panel included in the display 160. Accordingly, when the coordinate information of the first touch input is not converted, the electronic device 101 may not operate as intended by the user through the first touch input. Accordingly, when the orientation information of the display 160 and the orientation information of the virtual display are different from each other, the coordinate information of the first touch input may need to be converted to correspond to the orientation information of the virtual display.

According to various embodiments of the present disclosure, the processor 120 may receive information indicating that a second touch input corresponding to a second portion of the first content element is received from the electronic device 102 or 104. When the processor 120 receives the information within a preset time after the first touch input is received, the processor 120 may recognize the first touch input and the second input as a multi-touch input. As described above, although the second touch input is received through the display of the electronic device 102 or 104, the processor 120 may recognize the first touch input and the second touch input corresponding to the area displaying the first content element as the multi-touch input. Further, the processor 120 may transmit information indicating that the first touch input corresponding to the first portion of the first content element is received to the electronic device 102 or 104 through the communication interface 170. Accordingly, the electronic device 102 or 104 may also recognize the first touch input and the second touch input as the multi-touch input.

According to various embodiments of the present disclosure, the processor 120 may identify a Z-order of each of the one or more content elements. Further, the processor 120 may display each of the one or more content elements on the display based on the identified Z-order. As described above, the processor 120 may configure the Z-order according to each content element rather than according to each display. Further, the processor 120 may identify an arrangement order of each of the one or more content elements in a Z-direction based on the configured Z-order without consideration of the display corresponding to each of the one or more content elements. The processor 120 may display each of the one or more elements on the display 160 according to the identified arrangement order of the Z-direction.

As described above, according to various embodiments of the present disclosure, when the display 160 displays the first content element based on a first orientation, the processor 120 may control the display to display a first area of the second content element on the first display based on a second orientation. Further, when the display of the electronic device 102 or 104 displays the third content element based on a third orientation, the processor 120 may control the display to display a second area of the second content element on the display of the electronic device 102 or 104 based on the second orientation. As described above, the processor 120 may display the content element based on an orientation different from least one of the orientation of the display 160 and the orientation of the electronic device 102 or 104 by using the orientation information of the virtual display.

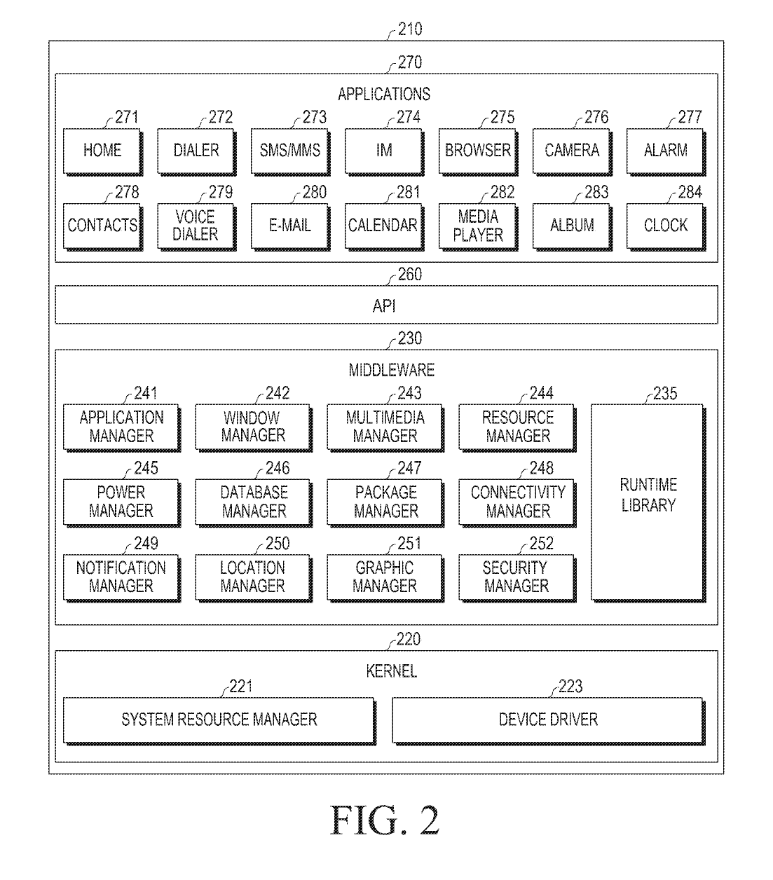

FIG. 2 is a block diagram of a program module according to various embodiments of the present disclosure.

Referring to FIG. 2, according to an embodiment of the present disclosure, the program module 210 (for example, the program 140) may include an OS for controlling resources related to the electronic device (for example, the electronic device 101) and/or various applications (for example, the application programs 147) executed in the operating system. The operating system may be, for example, ANDROID, IOS, WINDOWS, SYMBIAN, TIZEN, BADA, or the like.

The programming module 210 may include a kernel 220, middleware 230, an API 260, and/or applications 270. At least some of the program module 210 may be preloaded in the electronic device or downloaded from an external electronic device (for example, the electronic device 102 or 104, or the server 106).

The kernel 220 (for example, the kernel 141) may include, for example, a system resource manager 221 and/or a device driver 223. The system resource manager 221 may be configured to control, allocate, or collect system resources. According to an embodiment of the present disclosure, the system resource manager 221 may include a process manager, a memory manager, and/or a file system manager. The device driver 223 may include, for example, a display driver, a camera driver, a Bluetooth driver, a shared-memory driver, a USB driver, a keypad driver, a Wi-Fi driver, an audio driver, and/or an inter-process communication (IPC) driver.

The middleware 230 may provide a function required by the applications 270 in common or provide various functions to the applications 270 through the API 260 so that the applications 270 can efficiently use limited system resources within the electronic device. According to an embodiment of the present disclosure, the middleware 230 (for example, the middleware 143) may include, for example, at least one of a runtime library 235, an application manager 241, a window manager 242, a multimedia manager 243, a resource manager 244, a power manager 245, a database manager 246, a package manager 247, a connectivity manager 248, a notification manager 249, a location manager 250, a graphic manager 251, and/or a security manager 252.

The runtime library 235 may include, for example, a library module that a compiler uses to add new functions through a programming language while the application 270 is executed. The runtime library 235 may be configured to perform input/output management, memory management, and/or a function for an arithmetic function.

The application manager 241 may be configured to manage, for example, a life cycle of at least one of the applications 270. The window manager 242 may be configured to manage graphical user interface (GUI) resources used by a screen. The multimedia manager 243 may be configured to obtain formats required for the reproduction of various media files, and may perform an encoding or decoding of the media file by using a coder/decoder (codec) suitable for the corresponding format. The resource manager 244 may be configured to manage resources such as a source code, a memory, and a storage space of at least one of the applications 270.

The power manager 245 may be configured to operate together with a basic input/output system (BIOS) to manage a battery or power and may provide power information required for the operation of the electronic device. The database manager 246 may be configured to generate, search for, or change a database to be used by at least one of the applications 270. The package manager 247 may be configured to manage the installation or the updating of applications distributed in the form of package file.

The connectivity manager 248 may be configured to manage wireless connection of, for example, Wi-Fi or Bluetooth. The notification manager 249 may be configured to display or provide notification of an event such as an arrival message, promise, proximity notification, and the like in such a way that does not disturb a user. The location manager 250 may be configured to manage location information of the electronic device. The graphic manager 251 may be configured to manage graphic effects to be provided to a user and user interfaces related to the graphic effects. The security manager 252 may be configured to provide security functions required for system security or user authentication. According to an embodiment of the present disclosure, when the electronic device (for example, electronic device 101) has a call function, the middleware 230 may further include a telephony manager configured to manage a voice call function or a video call function of the electronic device.

The middleware 230 may include a middleware module for forming a combination of various functions of the aforementioned components. The middleware 230 may provide modules specialized according to types of operating systems in order to provide differentiated functions. Further, the middleware 230 may dynamically remove some of the existing components or add new components.

The API 260 (for example, the API 145) is, for example, a set of API programming functions where a different programming function configuration may be associated with each operating system platform. For example, with respect to each platform, one API set may be provided for ANDROID OR IOS platforms, and two or more API sets may be provided for the TIZEN platform, etc.

The applications 270 (for example, the application programs 147) may include, for example, one or more applications which can provide functions such as home 271, dialer 272, short message service (SMS)/multimedia message service (MMS) 273, instant message (IM) 274, browser 275, camera 276, alarm 277, contacts 278, voice dialer 279, e-mail 280, calendar 281, media player 282, album 283, and clock 284. Other additional applications not illustrated in FIG. 2 may also be included such as health care (for example, measure exercise quantity or blood sugar) applications environment information (for example, atmospheric pressure, humidity, or temperature information) applications, etc.

According to an embodiment of the present disclosure, the applications 270 may include an application (hereinafter, referred to as an “information exchange application” for convenience of the description) supporting information exchange between the electronic device (for example, the electronic device 101) and an external electronic device (for example, the electronic device 102 or 104). The information exchange application may include, for example, a notification relay application for transferring predetermined information to an external electronic device or a device management application for managing an external electronic device.

For example, the notification relay application may include a function of transferring, to the external electronic device (for example, the electronic device 102 or 104), notification information generated from other applications of the electronic device 101 (for example, an SMS/MMS application, an e-mail application, a health management application, or an environmental information application). Further, the notification relay application may receive notification information from, for example, the external electronic device and provide the received notification information to the user.

The device management application may manage (for example, install, delete, and/or update), for example, a function for at least a part of the external electronic device (for example, the electronic device 102 or 104) communicating with the electronic device (for example, turning on/off the external electronic device itself (or some elements thereof) or adjusting brightness (or resolution) of a display, applications executed in the external electronic device, and/or services provided from the external electronic device (for example, a telephone call service or a message service).

According to an embodiment of the present disclosure, the applications 270 may include applications (for example, a health care application of a mobile medical appliance or the like) designated according to attributes of the external electronic device 102 or 104. According to an embodiment of the present disclosure, the applications 270 may include an application received from the external electronic devices (for example, the server 106 and/or the electronic devices 102 or 104). According to an embodiment of the present disclosure, the applications 270 may include a preloaded application or a third party application which can be downloaded from the server. Names of the components of the program module 210 according to the above described embodiments may vary depending on the type of operating system.

According to various embodiments of the present disclosure, at least some of the programming module 210 may be implemented in software, firmware, hardware, or a combination of two or more thereof. At least some of the programming module 210 may be implemented (for example, executed) by, for example, the processor (for example, the processor 120). At least some of the programming module 210 may include, for example, a module, program, routine, sets of commands, or process for performing one or more functions.

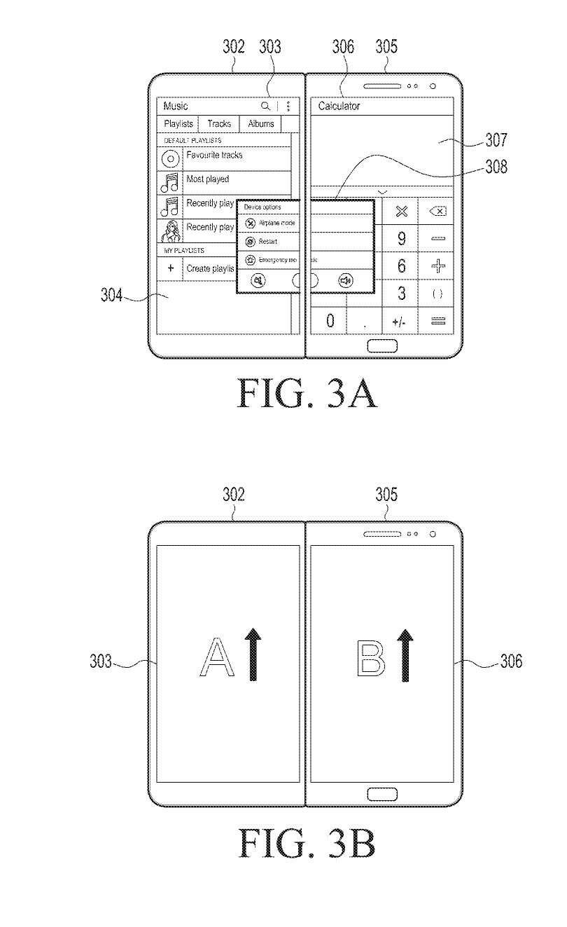

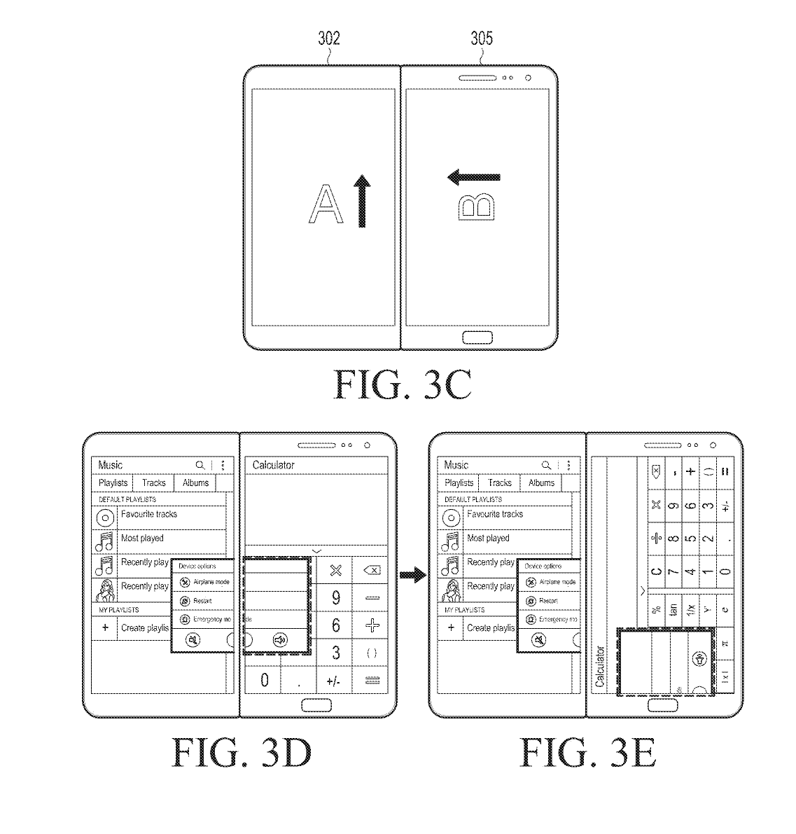

FIGS. 3A, 3B, 3C, 3D, and 3E are views for describing a content display method according to a comparative example of various embodiments of the present disclosure.

Referring to FIG. 3A, two electronic devices 302, 304 according to a comparative example may be connected to each other to construct a multi-display system. The two electronic devices 302, 305 may display separate content elements 304, 307 on each display 303, 306, respectively, and one content element 308 may be displayed over the respective displays. In the exemplary embodiment illustrated in FIG. 3A, a first content element 304 is associated with a media application, a second content element 307 is associated with a calculator, and a third content element 308 is associated with device options. It is noted that the content elements may be associated with any type of application where each content element is associated with a different application. Alternatively, two or more content elements may be associated with the same application.

FIG. 3B illustrates an orientation of each display. For example, content displayed on display A of electronic device 302 and content displayed on display B of electronic device 305 are oriented in the same direction, for example an up direction as illustrated by the arrows. The two electronic devices 302, 305 may simultaneously support an operation mode in which each display 303, 306 has an individual orientation and individually displays content elements and an operation mode in which the two displays have a common orientation where one content element is displayed over the two displays 303, 306.

Referring to FIG. 3B, a direction pointed toward by an arrow indicating each of the orientations of the display A and the display B may be a direction in which the top of the content is displayed on each of the displays. Hereinafter, the direction of the arrow indicating the orientation of the display may be the direction in which the top of the content is displayed on the display.

As described above, when each of the orientations of the display A and the display B is the same as the orientation of the entire area, the two electronic devices 302, 305 according to a comparative example may display the content elements as illustrated in FIG. 3A.

Unlike FIGS. 3A and 3B, when the orientation of the display B is changed in a left direction such that the orientations of the two electronic devices 302, 305 are different is illustrated in FIG. 3C.

In general, when content elements are generated, displays can be designated in which to display the content elements within the display area. In an exemplary embodiment, the content elements may be displayed within a window or other similar interface; however, the content elements may be displayed using any type of interface. In addition, the content elements may be displayed according to state information of the corresponding displays. For example, when the orientation information of the display is changed, such as by using a pivot function or a rotation sensing function through a sensor, the content elements displayed on the rotated display may be also changed in accordance with the changed orientation information as illustrated in FIG. 3E.

Accordingly, when the electronic device maps the content elements to the physical displays to display the content elements, the content elements displayed over the display A and the display B are rotated and displayed according to the orientations of the display A and the display B as illustrated in FIG. 3E, so that the content elements are separated and may not be continuously displayed.

In an exemplary embodiment, as illustrated in FIG. 3D, electronic devices 302 and 305 are oriented in the same direction such that the content elements are displayed such that content is displayed from the top to the bottom of display A and display B.

Referring to FIG. 3E, when the orientation of display B is changed with respect to display A, the content associated with display A may be displayed still from the top to the bottom. However, the content associated with display B may be displayed from the left to the right in the display B. As described above, as the orientation of the display B is changed, the orientation of the portion of the content elements displayed on the display B, including the content element that overlaps display A and display B. Accordingly, the content element displayed within the display area such that a portion of the content element is displayed in display A and a portion of the content element is displayed in display B may be divided and discontinuously displayed as illustrated in FIG. 3E.

As described above, the electronic devices 302, 305 according to the comparative example use only the physical displays and thus are limited when the orientations of at least one of the displays is changed. Accordingly, when the orientation of the display is changed, orientations of the content elements displayed on the display may be changed and content elements displayed over a plurality of displays may be divided and displayed.

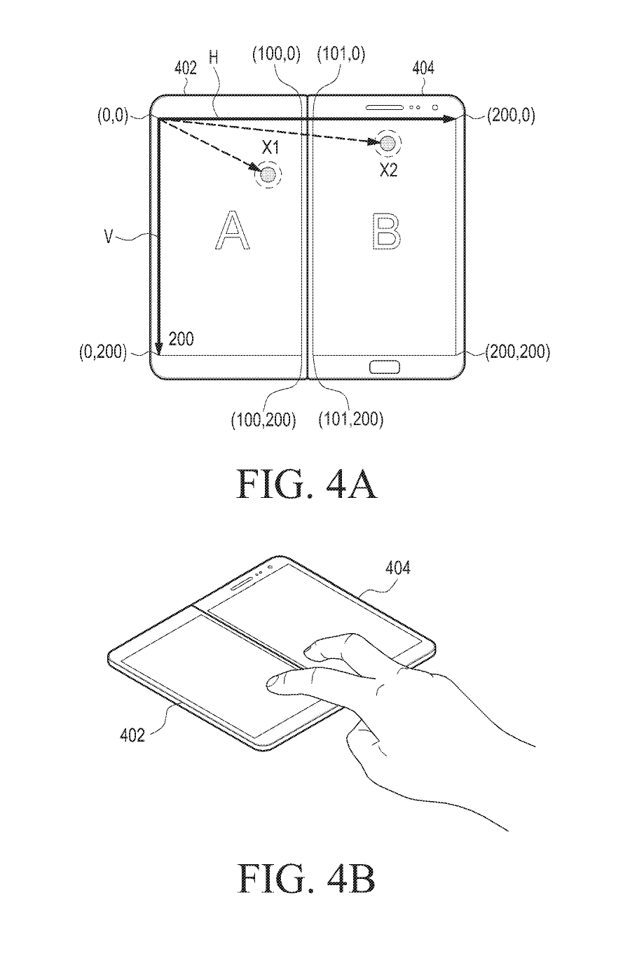

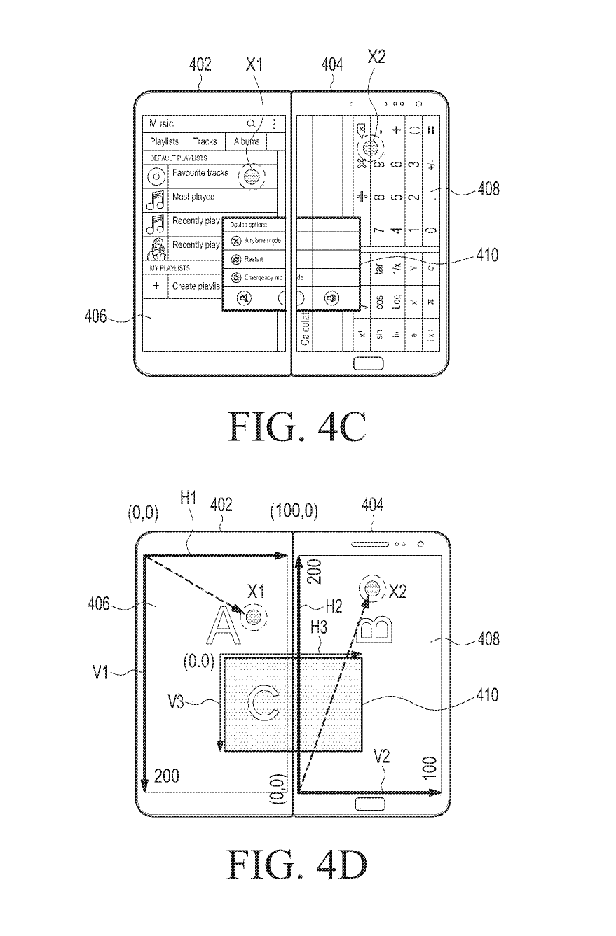

FIGS. 4A, 4B, 4C, and 4D are views for describing a method of recognizing a plurality of touch inputs according to a comparative example of various embodiments of the present disclosure.

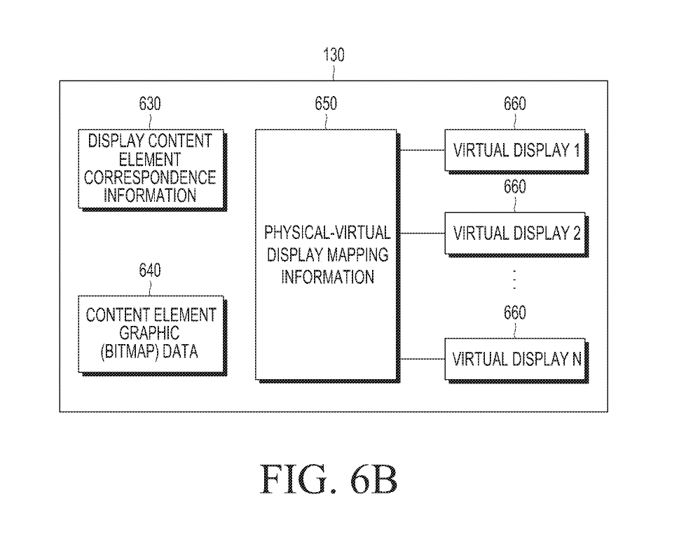

Referring to FIG. 6A, when two electronic devices 402, 404 according to a comparative example are connected to each other to construct a multi-display system, a coordinate system may be formed in an expansion mode or a full screen mode. When display A and display B have the same orientation, the display area may be determined such that display A and display B are combined and treated as one display for the purposes of coordinate assignment. For example, the display area may be defined to include 200 elements in the horizontal direction (H) and 200 elements in the vertical direction (V) such that a coordinate value of (0, 0) is assigned to an upper left side of display A, a coordinate value of (100,0) is assigned to an upper right side of display A, a coordinate value of (101,0) is assigned to an upper left side of display B, a coordinate value of (200, 0) is assigned to an upper right side of display B, a coordinate value of (0, 200) is assigned to a lower left side of display A, a coordinate value of (100, 200) is assigned to a lower right side of display A, a coordinate value of (101, 200) is assigned to a lower left side of display B, and a coordinate value of (200, 200) is assigned to a lower right side of display B as illustrated in FIG. 4A.

Referring to FIG. 4B, the user may touch each of the two electronic devices 402, 404, which are configured to operate in both a multi-display mode and a full screen mode. When the displays of electronic devices 402, 404 are oriented in the same direction, the two electronic devices 402, 404 may receive a first touch input X1 and a second touch input X2 on each display, respectively, and process the first touch input X1 and the second touch input X2 as a multi-touch input as illustrated in FIG. 4A.

However, when the orientations of display A and display B are different as illustrated in FIG. 4C, the first touch input X1 received on display A and the second touch input X2 received on display B may not be recognized as a multi-touch input. For example, when the orientations of display A and display B are different as illustrated in FIG. 4C, a display area associated with display A and display B cannot be formed using one coordinate system. Accordingly, display A and display B may each individually process the first touch input X1 associated with a first content element 406 and the second touch input X2 associated with a second content element 408 received through the respective touch panels as single touch inputs.

In an exemplary embodiment, as illustrated in FIG. 4D, each content element may be assigned a different coordinate system. For example, the first content element 406 may be associated with a first coordinate system including a first horizontal coordinate axis (H1) and a first vertical coordinate axis (V1), the second content element 408 may be associated with a second coordinate system including a second horizontal coordinate axis (H2) and a second vertical coordinate axis (V2), and the third content element 410 may be associated with a third coordinate system including a third horizontal coordinate axis (H3) and a second vertical coordinate axis (V3). The first coordinate system may be defined such that a coordinate value of (0, 0) is assigned to a upper left corner of the content element 406, a coordinate value of (0, 200) is assigned to a lower left corner of the content element 406, a coordinate value of (100, 0) is assigned to an upper right corner of the content element 406, and a coordinate value of (100, 200) is assigned to a lower right corner of the content element 406. The second coordinate system may be defined such that a coordinate value of (0, 0) is assigned to an upper left corner of the content element 408, a coordinate value of (200, 0) is assigned to an upper right corner of the content element 408, a coordinate value of (0, 100) is assigned to a lower left corner of the content element 408, and a coordinate value of (100, 200) is assigned to a lower right corner of the content element 408. It is noted that the orientation of the first content element 406 displayed on the first electronic device 402 is oriented in a different direction from the second content element 408 displayed on the second electronic device 404. For example, the coordinate value of (100, 200) corresponding to a lower right corner of the first content element 406 may be adjacent to the coordinate value (0, 0) associated with an upper left corner of the second content element 408. In addition, the third coordinate system may be defined to overlap the first content element 406 and the second content element 408. In an exemplary embodiment, a coordinate value of (0, 0) associated with the third content element 410 may overlap and/or correspond to a coordinate value in the coordinate system associated with the first content element 406

Further, as illustrated in FIGS. 4D, the third content element 410 displayed in both display A and display B may be displayed such that a first portion 411 of the third content element 410 and a second portion 413 of the third content element form a continuous element using a virtual display. In addition, the first touch input X1 and the second touch input X2 may be detected at display A and display B. However, in this case, the first touch input X1 and the second touch input X2 may be individually processed as single touch inputs due to the different orientations of the first content element 406 and the second content element 408.

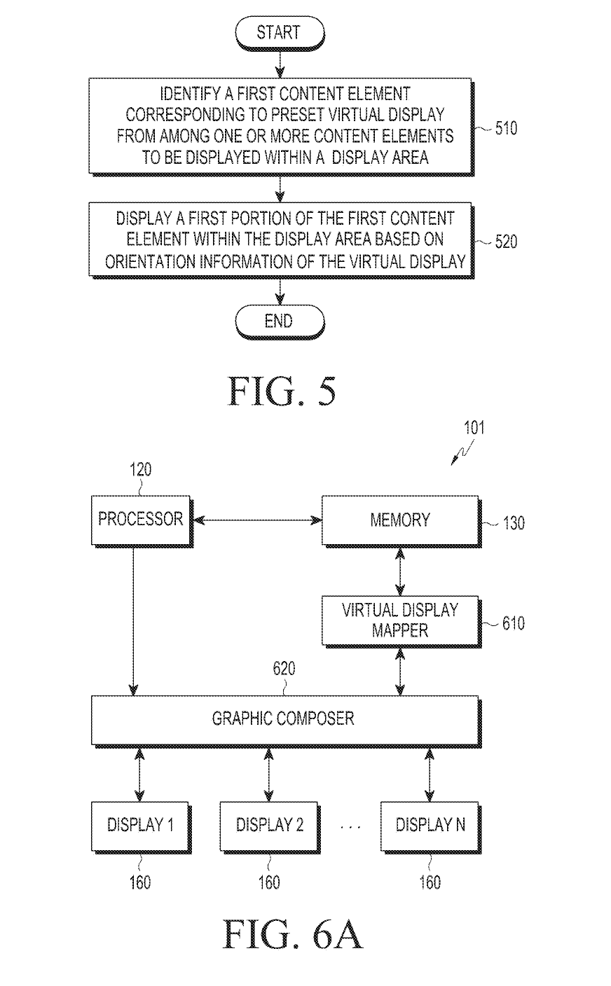

FIG. 5 is a flowchart illustrating a content element display method by an electronic device according to various embodiments of the present disclosure.

Referring to FIG. 5, in operation 510, a first content element corresponding to a preset virtual display is identified from among one or more content elements to be displayed within a display area. The display area is the area available to display information. For example, when two or more electronic devices are connected to establish a multi-display system, the display area corresponds to the number of displays such that when two electronic devices are connected the display area includes the area associated with the display of the first electronic device and the area associated with the second electronic device. Each of the one or more content elements may be identified, selected, or determined based on at least one of a user input, configuration information of an operating system, and/or configuration information of an application.

For example, the electronic device 101 may identify the first content element based on at least one of the user input, configuration information of the operating system, and configuration information of the application. The user may configure the first content element to correspond to a first display or the first content element may be automatically configured to correspond to the first display according to the configuration information of the operating system and the configuration information of the application.

In operation 520, a first portion of the first content element may be displayed within the display area based on orientation information of the virtual display. For example, electronic device 101 may display the first portion of the first content element based on an orientation corresponding to the orientation information of the virtual display on the display 160.

Further, the electronic device 101 may display the first portion of the first content element by using mapping information between the display 160 and the virtual display. The mapping information may be configured based on state information of the display 160 and state information of the virtual display.

FIG. 6A is a block diagram of an electronic device according to various embodiments of the present disclosure.

The electronic device 101 according to various embodiments of the present disclosure may be illustrated as the block diagram of FIG. 6A. The electronic device 101 may include the processor 120, the memory 130, at least one display 160, a virtual display mapper 610, and a graphic composer 620.

The processor 120 may be configured to transmit graphic (bitmap) data of content elements included in the memory 130 to the graphic composer 620 to instruct the display 160 to display the content elements.

The memory 130 may include graphic (bitmap) data of content elements to be displayed on the display 160, display-content correspondence information to indicate which content elements are displayed on the display 106, physical-virtual display mapping information, and state information of the virtual display. Each piece of the information included in the memory 130 will be described below with reference to FIG. 6B.

The virtual display mapper 610 may determine a portion of a content element, which is displayed on a physical display, from among the graphic (bitmap) data of the content elements according to the mapping information between the virtual display and the physical display, and divide the graphic (bitmap) data of the content elements. Further, the virtual display mapper 610 may rotate the graphic data of the elements according to orientation information of the virtual display.

As described above, before displaying the content elements corresponding to the virtual display on a frame buffer of the physical display, the virtual display mapper 610 may be configured to perform a separate preprocessing process on the content elements. The separate preprocessing process may perform an operation for dividing, rotating, and/or movement-transforming the graphic data of the content elements so that the content elements corresponding to the virtual display may be output to a proper location according to orientation information of the physical display and the virtual display, and the mapping information. The virtual display mapper 610 may be constructed separately from the processor 120 as illustrated in FIG. 6A or may be included in the processor 120 to operate with the processor 120 as one module.

The graphic composer 620 may be configured to compose the graphic (bitmap) data of the content elements in a buffer of the display 160. Through the composition of the graphic (bitmap) data of the content elements in the buffer of the display 160, the content elements may be displayed on the display 160.

Each of the one or more displays 160 may correspond to an output buffer for displaying the graphic information of the content elements on the display. In general, the output buffer may be used during a step of constructing the screen before outputting the final screen by a graphic driver. Each of the one or more displays 160 may display the content elements temporarily stored in the corresponding output buffer and outputted.

FIG. 6B is a block diagram for describing information included in the memory of the electronic device according to various embodiments of the present disclosure.

Referring to FIG. 6B, the memory 130 of the electronic device 101 according to various embodiments of the present disclosure may include display-content element correspondence information 630, content element graphic (bitmap) data 640, physical-virtual display mapping information 650, and state information 660 on at least one virtual display in order to display content elements using the virtual display.

The display-content correspondence information 630 may be information indicating a correspondence relation between one or more content elements to be displayed on the display 160 and a display predetermined when each of the one or more content elements are generated. The one or more content elements may be displayed on the corresponding displays, respectively. The processor 120 may identify a first content element corresponding to the virtual display among the one or more content elements according to the display-content correspondence information 640 included in the memory 160.

The content element graphic (bitmap) data 640 is data associated with each of the one or more content elements included in the memory 160.

The physical-virtual display mapping information 650 may be generated based on state information of the display 160 and state information of the virtual display. The processor 120 may generate the mapping information between the display 160 and the virtual display by using the size or location of the virtual display configured during a process of generating the virtual display. When the size or location of the virtual display is not configured, the processor 120 may configure information on the size or location of the virtual display by default.

The state information 660 associated with the one or more virtual displays may include display context of the displays. The display context corresponds to information indicating a display state and may include various pieces of information expressing a display state such as a width, a height, a density, and an orientation. The processor 120 may configure the virtual display by configuring state information such as context of the virtual display. Further, the processor 120 may store the state information corresponding to the configured virtual display in the memory 160 according to the configuration of the virtual display.

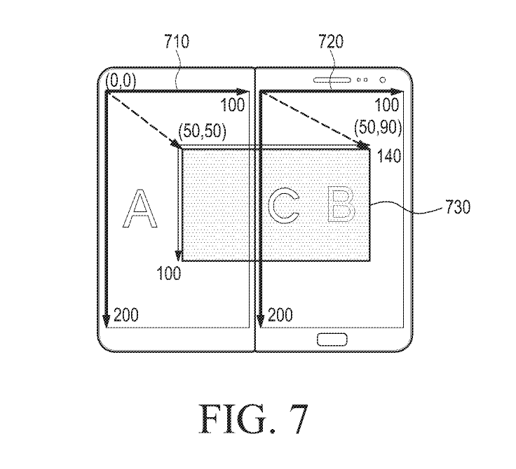

FIG. 7 is a view for describing a state where a virtual screen is mapped by the electronic device according to various embodiments of the present disclosure.

The electronic device 101 according to various embodiments of the present disclosure may generate mapping information between a display area and the virtual display based on state information of the display 160 of the electronic device 101 and state information of the virtual display. Similarly, the electronic device 102 or 104 may also generate mapping information based on the state information of the virtual display received from the electronic device 101 and state information of the display of the electronic device 102 or 104.

Referring to FIG. 7, the virtual display may be mapped according to the generated mapping information. For example, it is assumed that state information of a virtual display C 730 includes size information containing a width of 140 and a height of 100, and location information of the virtual display 730 as illustrated in FIG. 7. In this case, an upper left vertex of the virtual display C 730 may be mapped to a location of (50, 50) based on an upper left vertex of the display A 710. Further, an upper right vertex of the virtual display C 730 may be mapped to a location of (50, 90) based on the upper left vertex of the display A 720. One of the remaining vertexes of the virtual display C 730 may be mapped to one of the display A 710 and the display B 720 based on the size information included in the state information of the virtual display.

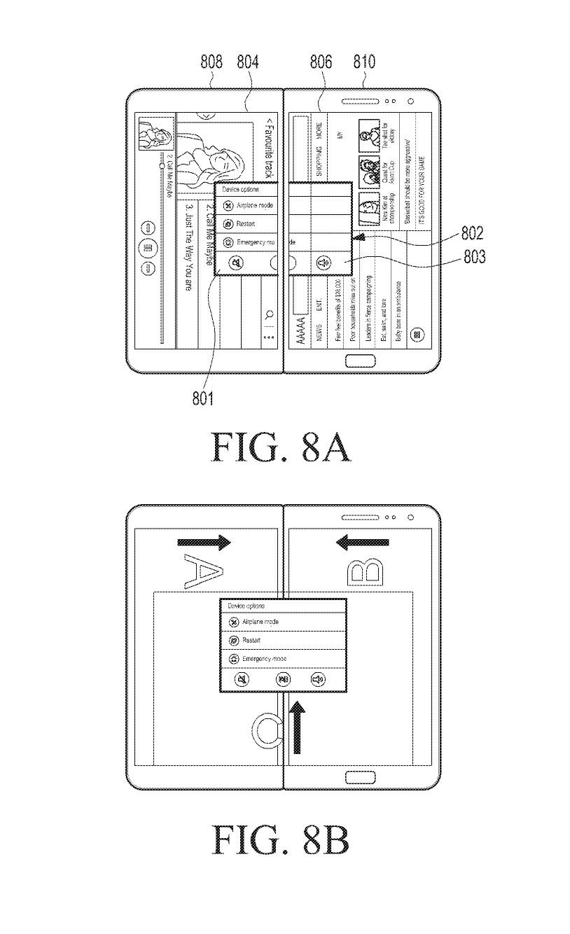

FIGS. 8A and 8B are views for describing a method of displaying contents through a virtual screen by the electronic device according to various embodiments of the present disclosure.

Referring to FIG. 8A, orientations of the display 160 of the electronic device 101 and the display of the electronic device 102 or 104 may be different from each other according to various embodiments of the present disclosure. Further, the orientation of the virtual display mapped to the display 160 and the display of the electronic device 102 or 104 may be also different from the orientations of the display 160 and the display of the electronic device 102 or 104.

According to various embodiments of the present disclosure, the electronic device 101 may configure orientation information of the virtual display during a process of configuring the virtual display. Accordingly, a first content element corresponding to the virtual display may be displayed to correspond to the orientation of the virtual display while the orientation of the virtual display is not influenced by the orientations of the display 160 and the display of the electronic devices 102 or 104.

Referring to FIG. 8A, a first content element 802, which shows device options on the virtual display, may be displayed over a second content element 804 and a third content element 806 where the second content element 804 is displayed on a first electronic device 808 and the second content element 804 is displayed on a second electronic device 810.

Further, the orientation information associated with each content element 804, 806 displayed on electronic devices 808, 810, respectively, and the content element 802 associated with the virtual display may be as illustrated in FIG. 8B. For example, the orientation information associated with content element 804 may correspond to a right direction, the orientation information associated with content element 806 may correspond to a left direction, and the orientation information of the content element 802 associated with the virtual display may correspond to an up direction.

Referring to FIG. 8B, when the orientations are different, electronic device 808 may display a first portion 801 of content element 802 on the display based on orientation information of the virtual display. Similarly, the electronic device 810 may display a second portion 803 of the content element 802 on the display of the electronic device 810 based on orientation information of the virtual display. Accordingly, although the orientations of the displays are different from each other, content element may be continuously displayed on the displays without any separation.

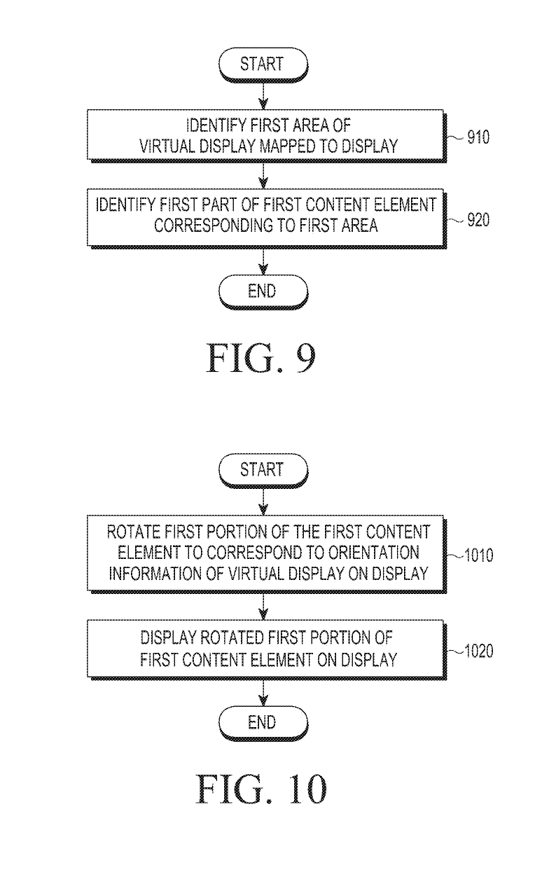

FIG. 9 is a flowchart illustrating a method of displaying the first portion of a content element on the display by the electronic device according to various embodiments of the present disclosure.

Referring to FIG. 9, in operation 910, the electronic device 808 or 810 may identify a first area of the virtual display mapped to the display of electronic device 808 based on the mapping information. When the entire virtual display is mapped to the display of electronic device 808, the whole first content element corresponding to the virtual display may be displayed on the display of electronic device 808. However, only a portion of the virtual display may be mapped to the display associated with electronic device 808. For example, the first area of the virtual display may be mapped to the display of electronic device 808, and a second area of the virtual display may be mapped to the display of electronic device 810. In this case, the electronic device 808 or 810 may identify the first area of the virtual display mapped to the display of electronic device 808.

In operation 920, the electronic device 808 or 810 may identify the first portion of the content element corresponding to the first area of the virtual display. As described above, when only a part of the virtual display is mapped to the display of the electronic device 808, the entire first content element may not be displayed on the display of the electronic device 808. In this case, the electronic device 808 or 810 may identify the first portion of the content element corresponding to the first area of the virtual display and display the identified first portion of the content element on the display of electronic device 808.

Similarly, the electronic device 810, which constructs the multi-display system together with the electronic device 808, may identify the second area of the virtual display mapped to the display of the electronic device 808 based on the state information of the virtual display received from the electronic device 808 or 810. The multi-display system may be a system in which two electronic devices use each other's displays.

Further, the electronic device 810 may identify the second portion of the content element corresponding to the second area of the virtual display and display the second portion of the content element on the display of the electronic device 810.

FIG. 10 is a flowchart illustrating a method of displaying the first portion of the first content element on the display by the electronic device according to various embodiments of the present disclosure.

Referring to FIG. 10, in operation 1010, the electronic device 808 may rotate the first portion of the content element to correspond to the orientation information of the virtual display on the display of electronic device 808. As described above, the virtual display may be a logical display rather than the physical display. Accordingly, the first portion of the content element corresponding to the virtual display may be displayed on a physical display to which the virtual display is mapped. Therefore, when the orientation information of the virtual display and the orientation information of the physical display are different from each other, the first portion of the content element may be displayed in accordance with the orientation information of the physical display.

However, only when the first portion of the content element is displayed based on the orientation information of the virtual display as a content element corresponding to the virtual display such that the discontinuous display as illustrated in FIG. 3E can be prevented. Accordingly, the electronic device 808 rotates the first portion of the content element to correspond to the orientation information of the virtual display on the display.

In operation 1020, the electronic device 808 may display the rotated first portion of the content element on the display of electronic device 808. Accordingly, the electronic device 808 may continuously display the first portion of the content element with the second portion of the content element, which is displayed on the display of the electronic device 810.

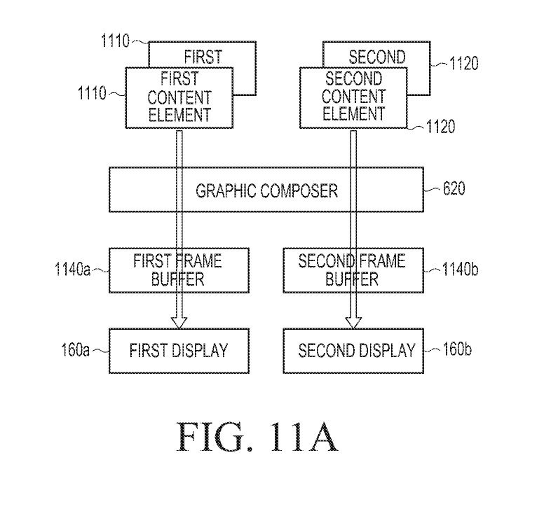

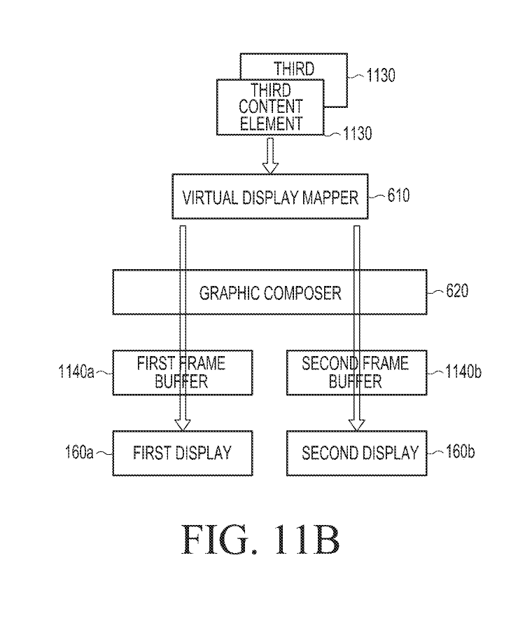

FIGS. 11A and 11B illustrate a method of displaying a plurality of content elements on a plurality of displays by the electronic device according to various embodiments of the present disclosure.

FIG. 11A illustrates an operation for outputting content elements 1110 and 1120 corresponding to physical displays on the physical displays.

Referring to FIG. 11A, the content elements 1110 and 1120 may correspond to the physical displays. For example, the first content element 1110 may correspond to a first display 160a and the second content element 1120 may correspond to a second display 160b. Hereinafter, it is assumed that the first display 160a corresponds to the display of the electronic device 101 and the second display 160b corresponds to the display of the electronic device 102 or 104 as illustrated in FIG. 1. The first content element 1110 may be transmitted to a first frame buffer 1140a of the first display 160a through the graphic composer 620, and the first frame buffer 1140a may transmit the first content element 1110 to the first display 160a to display the first content element 1110.

The second content element 1120 may be transmitted to a second frame buffer 1140b of the second display 160b through the graphic composer 620, and the second frame buffer 1140b may transmit the second content element 1120 to the second display 160b to display the second content element 1120.

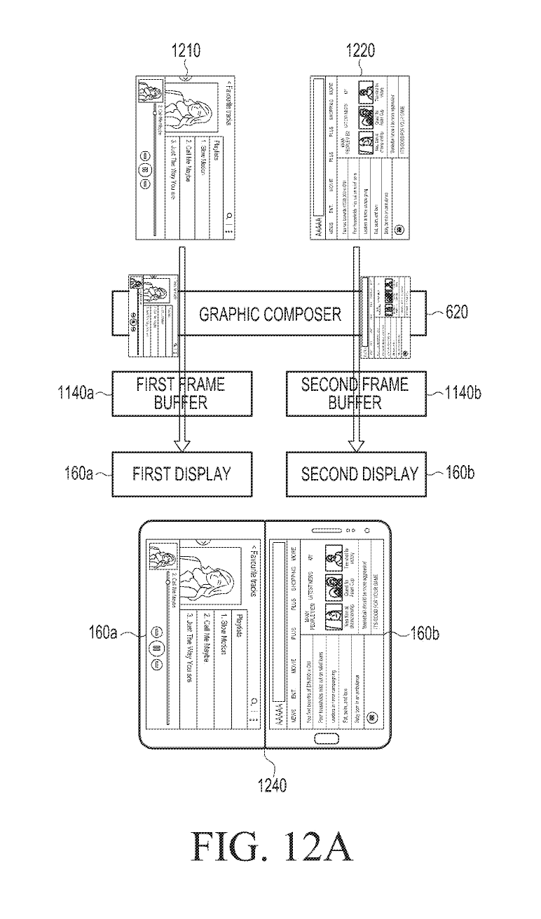

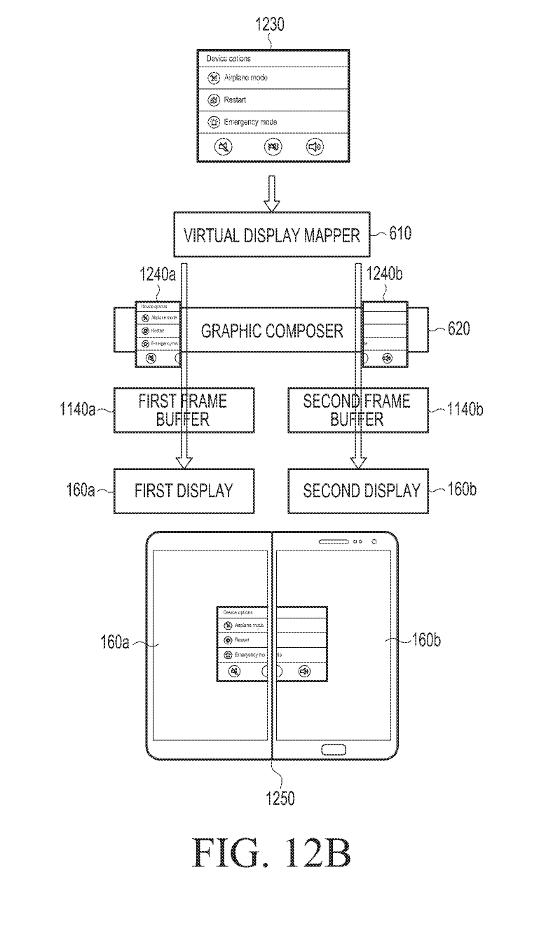

FIG. 11B illustrates an operation for outputting a third content element 1130 corresponding to the virtual display on the virtual display. The virtual display mapper 610 included in each of the electronic device 101 and the electronic device 102 or 104 is illustrated as one block in FIGS. 11B and 12B for the convenience of description.

Referring to FIG. 11B, the virtual display mapper 610 may separate, rotate, or movement-transform the third content element 1130 in order to display the third content element 1130 corresponding to the virtual display on the first display 160a and the second display 160b.

For example, the virtual display mapper 610 of the electronic device 101 may identify the first area of the virtual display mapped to the first display 160a by using mapping information between the virtual display and the first display 160a. Further, the virtual display mapper 610 may identify the first portion of the third content element 1130 corresponding to the first area.

Similarly, the virtual display mapper 610 of the electronic device 102 or 104 may also identify the second area of the virtual display mapped to the second display 160b by using mapping information between the virtual display and the second display 160b. Further, the virtual display mapper 610 may identify the second portion of the third content element 1130 corresponding to the first area.

The virtual display mapper 610 may separate the third content element 1130 into the first portion and the second portion. Further, the virtual display mapper 610 may rotate the first portion of the third content element 1130 to correspond to orientation information of the virtual display on the first display 160a. Similarly, the virtual display mapper 610 may rotate the second portion of the third content element 1130 to correspond to orientation information of the virtual display on the second display 160b.

The rotated first portion of the third content element 1130 may be transmitted to the first frame buffer 1140a of the first display 160a through the graphic composer 620, and the first frame buffer 1140a may transmit the rotated first portion of the third content element 1130 to the first display 160a to output the rotated first portion of the third content element 1130.

The rotated second portion of the third content element 1130 may be transmitted to the second frame buffer 1140b of the second display 160b through the graphic composer 620, and the second frame buffer 1140b may transmit the rotated second portion of the third content element 1130 to the second display 160b to output the rotated second portion of the third content element 1130.

FIGS. 12A and 12B illustrate a method of displaying a plurality of content elements on a plurality of displays by the electronic device according to various embodiments of the present disclosure.

FIG. 12A illustrates an operation for outputting content elements 1210 and 1220 corresponding to physical displays on the physical displays.

Referring to FIG. 12A, the content elements 1210 and 1220 may correspond to the physical displays. For example, the first content element 1210 may correspond to the first display 160a and the second content element 1220 may correspond to the second display 160b. Hereinafter, it is assumed that the first display 160a corresponds to the display of the electronic device 101 and the second display 160b corresponds to the display of the electronic device 102 or 104.

The first content element 1210 may be transmitted to the first frame buffer 1140a of the first display 160a through the graphic composer 620, and the first frame buffer 1140a may transmit the first content element 1210 to the first display 160a to output the first content element 1210.

The second content element 1220 may be transmitted to the second frame buffer 1140b of the second display 160b through the graphic composer 620, and the second frame buffer 1140b may transmit the second content element 1120 to the second display 160b to output the second content element 1220.

Accordingly, in a multi-display system 1240 constructed between the electronic device 101 and the electronic device 102 or 104, the first content element 1210 and the second content element 1220 may be displayed on the first display 160a and the second display 160b. Although the first content element 1210 and the second content element 1220 are illustrated as separate content elements in FIG. 12A, the present disclosure is not limited thereto, and the first content element 1210 and the second content element 1220 may be the same content elements or partial screens of the entire screens.

FIG. 12B illustrates an operation for outputting a third content element 1230 corresponding to the virtual display on the virtual display.

Referring to FIG. 12B, the virtual display mapper 610 may separate, rotate, or movement-transform the third content element 1230 in order to display the third content element 1230 corresponding to the virtual display on the first display 160a and the second display 160b.

For example, the virtual display mapper 610 of the electronic device 101 may identify the first area of the virtual display mapped to the first display 160a by using mapping information between the virtual display and the first display 160a. Further, the virtual display mapper 610 may identify a first portion 1240a of the third content element 1240 corresponding to the first area.

Similarly, the virtual display mapper 610 of the electronic device 102 or 104 may also identify the second area of the virtual display mapped to the second display 160b by using mapping information between the virtual display and the second display 160b. Further, the virtual display mapper 610 may identify a second portion 1240b of the third content element corresponding to the second area.

The virtual display mapper 610 may separate the third content element 1230 into the first portion 1240a and the second portion 1240b. Further, the virtual display mapper 610 may rotate the first portion 1240a of the third content element 1240 to correspond to orientation information of the virtual display on the first display 160a. Similarly, the virtual display mapper 610 may rotate the second portion 1240b of the third content element 1230 to correspond to orientation information of the virtual display on the second display 160b.

The rotated first portion 1240a of the third content element 1240 may be transmitted to the first frame buffer 1140a of the first display 160a through the graphic composer 620, and the first frame buffer 1140a may transmit the rotated first portion 1240a of the third content element 1240 to the first display 160a to display the rotated first portion 1240a of the third content element 1240.

The rotated second portion 1240b of the third content element 1240 may be transmitted to the second frame buffer 1140b of the second display 160b through the graphic composer 620, and the second frame buffer 1140b may transmit the rotated second portion 1240b of the third content element 1240 to the second display 160b to display the rotated second portion 1240b of the third content element 1240.

Accordingly, in a multi-display system 1250 constructed between the electronic device 101 and the electronic device 102 or 104, the third content element 1230 may be continuously displayed over the first display 160a and the second display 160b.

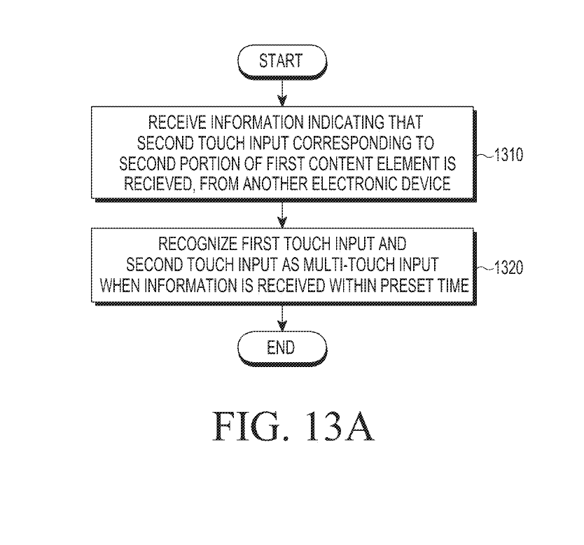

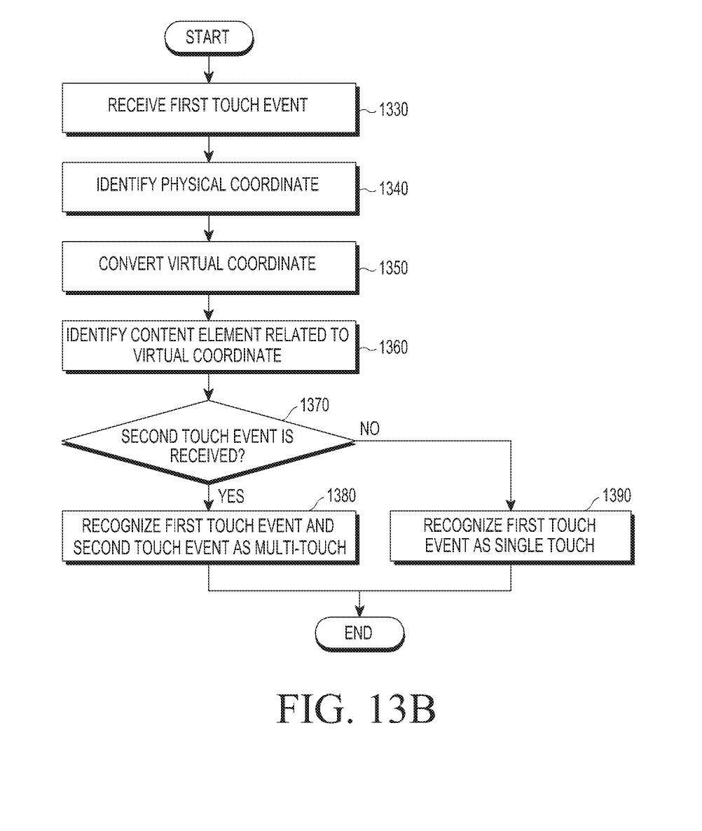

FIGS. 13A and 13B are flowcharts illustrating a method of recognizing a plurality of touch inputs by the electronic device according to various embodiments of the present disclosure.

Referring to FIG. 13A, in operation 1310, the electronic device 101 may receive information indicating that a second touch input corresponding to the second portion of the first content element is received at the electronic device 102 or 104. As described above, the electronic device 102 or 104 may construct the multi-display system through a connection to the electronic device 101 and display the second portion of the third content element. Further, the electronic device 101 may also transmit information indicating that a first touch input corresponding to the first portion of the third content element is received at the electronic device 102 or 104.

In operation 1320, when the electronic device 101 receives the information within a preset time, the electronic device 101 may recognize the first touch input and the second touch input as a multi-touch input.

The method of recognizing the plurality of touch inputs as the multi-touch input through transmission/reception of the information is only an example for the purpose of description, but the present disclosure is not limited thereto. The method of recognizing the plurality of touch inputs as the multi-touch input may be various. For example, hardware, a device driver, or an operating system may receive an indication of the plurality of touch inputs and transmit the touch inputs based on appointed regulations, and an electronic device having received the plurality of touch inputs may analyze the touch inputs according to a predetermined interface and recognize the touch inputs as the multi-touch.

A detailed implementation of the system and interface for recognizing the plurality of touch inputs as the multi-touch input may be various. However, in order to recognize the plurality of touch inputs as the multi-touch, content elements corresponding to the plurality of touch inputs and a coordinate system of the received touch inputs should be the same. This is because whether to recognize the touch inputs as the multi-touch is determined by comparing the coordinates of the content elements with the coordinates of the plurality of touch inputs.

FIG. 13B describes the method of recognizing the plurality of touch inputs by the electronic device 101 in detail.

Referring to FIG. 13B, in operation 1330, the electronic device 101 may receive a first touch event. In operation 1340, the electronic device 101 may identify a physical coordinate of the first touch event. The physical coordinate may be a physical coordinate of the display 160 indicating a location where the first touch event is received.

In operation 1350, the electronic device 101 may convert the physical coordinate of the first touch event into a virtual coordinate. For example, the electronic device 101 may identify the display 160, which receives the first touch event. The electronic device 101 may identify state information of the display 160, for example, orientation information of the display 160. Further, the electronic device 101 may convert the physical coordinate of the first touch event into the virtual coordinate based on the orientation information of the virtual display on the display 160. The virtual coordinate may be converted to correspond to the orientation information of the virtual display on the display 160.

In operation 1360, the electronic device 101 may display content related to the virtual coordinate. As described above, the content displayed on the display may be associated with the content elements.

In operation 1370, the electronic device 101 may identify whether a second touch event related to the content element is received by another electronic device, which displays at least a portion of the content element related to the virtual coordinate.

In operation 1380, when the electronic device 101 receives the second touch event within a predetermined time after receiving the first touch event, the electronic device 101 may recognize the first touch event and the second touch event as a multi-touch event.

In operation 1390, when the electronic device 101 does not receive the second touch event, the electronic device 101 may recognize the first touch event as a single touch event. Further, when the electronic device 101 receives the second touch event after a predetermined time passes from the reception of the first touch event, the electronic device 101 may recognize the first touch event as a single touch event.

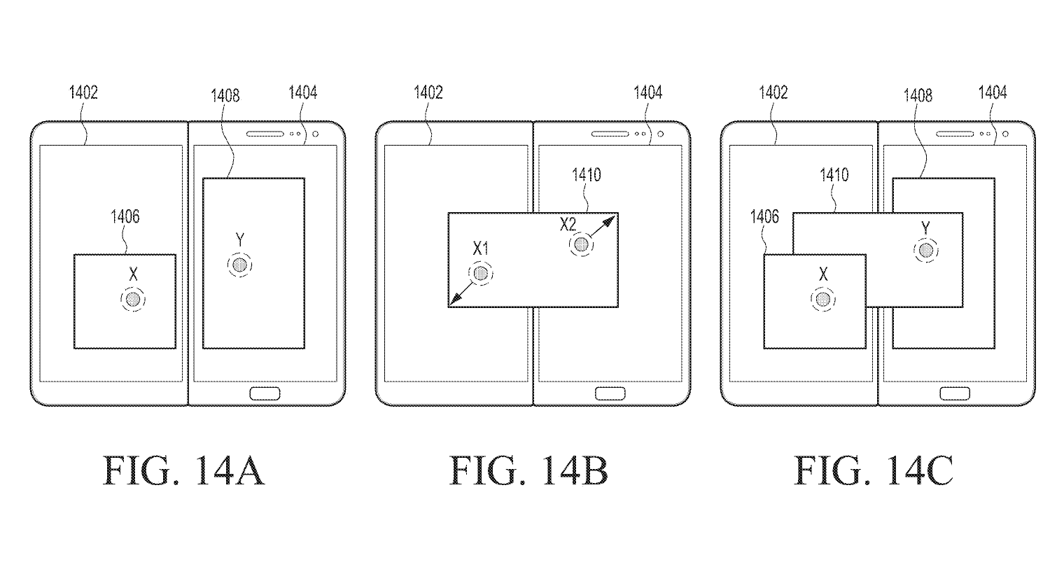

FIGS. 14A to 14C illustrate a method of recognizing a plurality of touch inputs by the electronic device according to various embodiments of the present disclosure.

FIGS. 14A to 14C describe a method of, when a plurality of touch inputs are received in the multi-display system, recognizing the touches according to locations of the plurality of touch inputs and a mapping state between the content and the virtual display.

FIG. 14A illustrates a case where separate content elements are displayed by a first display and a second display. In this case, a first touch input X may be received at the first display 1402 and a second touch input Y may be received at the second display 1404. A first content element 1406 may be associated with the first display 1402 and a second content element 1408 may be associated with the second display 1404. As described above, when the first touch input X and the second touch input Y are received at the separate displays 1402, 1404, each of the first touch input X and the second touch input Y may be recognized as a single touch input.

Referring to FIG. 14B, the virtual display is mapped to the first display 1402 and the second display 1404, and a content element 1410 corresponding to the virtual display is displayed on the first display 1402 and the second display 1404. In this case, a first touch input X1 and a second touch input X2 may be associated with the content element 1410. As described above, although the first touch input X1 and the second touch input X2 may be associated with the same content element 1410 even though the first touch input X1 and the second touch input X2 are received at separate displays 1402, 1404, the first touch input X1 and the second touch input X2 may be recognized as a multi-touch input.

Referring to FIG. 14C, the virtual display is mapped to the first display 1402 and the second display 1404, and the content element 1410 corresponding to the virtual display is displayed on the first display 1402 and the second display 1404. Further, a first content element 1406 is displayed on the first display 1402 and a second content element 1408 is displayed on the second display 1404. In this case, a first touch input X may be received in an area associated with the content element 1406 displayed on the first display 1402, and a second touch input Y may be received in an area associated with the content element 1410 displayed on the second display 1404. As described above, when the first touch input X and the second touch input Y are received in the separate content elements, each of the first touch input X and the second touch input Y may be recognized as a single touch input. In other words, the first touch input X is recognized as an input associated with content element 1406 and the second touch input Y is recognized as an input associated with content element 1410.

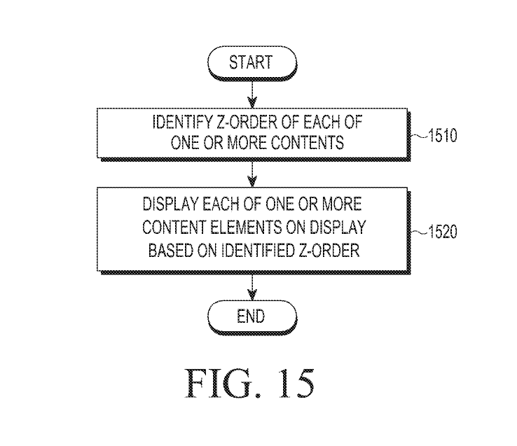

FIG. 15 is a flowchart illustrating a method of displaying each of the one or more content elements on the display according to a Z-order by the electronic device according to various embodiments of the present disclosure.

Referring to FIG. 15, in operation 1510, the electronic device 101 may identify the Z-order of each of the one or more content elements. The electronic device 101 may configure the Z-order according to each of the one or more content elements to be displayed on the display 160 without configuring the Z-order according to each display.

In operation 1520, the electronic device 101 may display each of the one or more content elements on the display 160 based on the identified Z-order. The electronic device 101 may identify an arrangement order of each of the one or more content elements in a Z-direction based on the configured Z-order, without consideration of the display corresponding to each of the one or more content elements. The electronic device 101 may display each of the one or more content elements on the display 160 according to the identified arrangement order of the Z-direction.

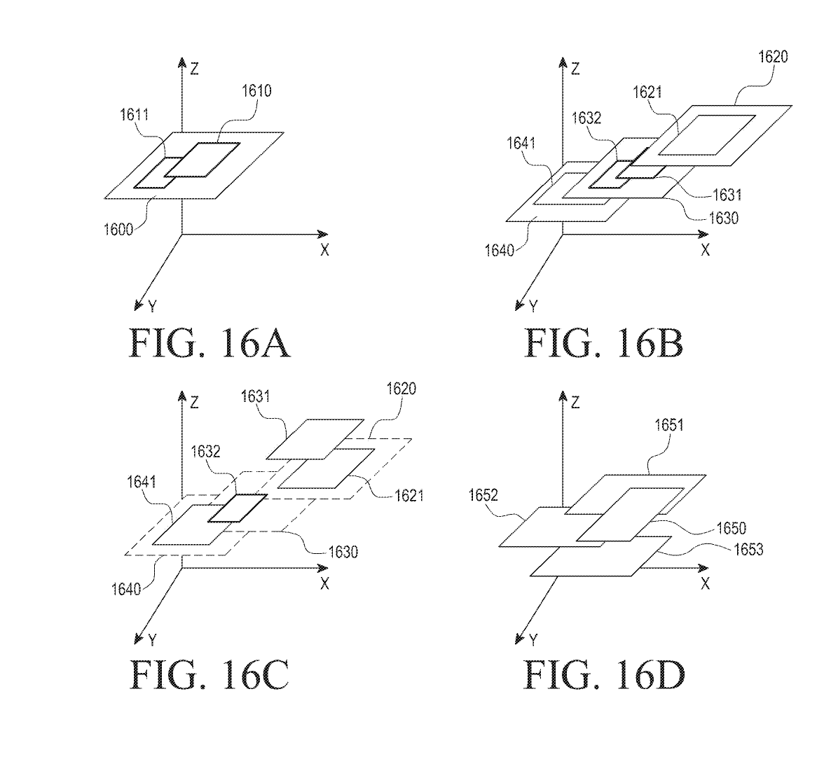

FIGS. 16A to 16D illustrate a method of displaying each of the one or more content elements on the display according to the Z-order by the electronic device according to various embodiments of the present disclosure.

FIG. 16A describes a case where content elements displayed on a first display 1600 are displayed according to the Z-order. For example, when the Z-order of a first content element 1610 is larger than the Z-order of a second content element 1611, the first content element 1610 may be displayed above the second content element 1611. Accordingly, in an area where the first content element 1610 and the second content element 1611 overlap each other, the first content element 1610 is shown.

FIG. 16B illustrates a method of displaying content elements according to the Z-order of the display.

Referring to FIG. 16B, the electronic device 101 may identify Z-orders of the displays corresponding to a plurality of content elements in order to display the plurality of content elements. For example, it is assumed that the Z-order of a first display 1620 is largest and the Z-order of a third display 1640 is smallest. In this case, a first content element 1621 corresponding to the first display 1620 may be displayed uppermost. A second content element 1631 and a third content element 1632 corresponding to a second display 1630 may be displayed above a fourth content element 1641 corresponding to a third display 1640.

However, since both the second content element 1631 and the third content element 1632 correspond to the second display 1630, Z-orders of each content element may be added. For example, it is assumed that the Z-order of the second content element 1631 is larger than the Z-order of the third content element 1632. In this case, the second content element 1631 may be displayed above the third content element 1632.

As described above, when the Z-order of the display is first considered and the corresponding displays are the same, the arrangement order of each of the one or more content element may be identified in consideration of the Z-order of each content element.

FIG. 16C illustrates a method of displaying each of the one or more content elements according to the Z-order of each of the one or more content elements without consideration of the Z-order of the display.

Referring to FIG. 16C, the Z-orders of the content elements may be ranked such that the second content element 1631 has the highest Z-order, then the first content element 1621, then the third content element 1632, and finally the fourth content element 1641, where the fourth content element 1641 has the lowest Z-order. In an exemplary embodiment, the second content element 1631 may be associated with a virtual display and the first content element 1621, the third content element 1632, and the fourth content element 1641 may be associated with physical displays such as the first display 1620, the second display 1630, and the third display 1640.

When the electronic device 101 displays the plurality of content elements according to the Z-orders of the plurality of content elements, the content element having the highest Z-order may be displayed on top. For instance, the second content element 1631 may be the content element outmost displayed on the display of the electronic device 101 because it has the highest Z-order in relation to the other content elements (e.g., the first content element 1621, the third content element 1632, and the fourth content element 1641) where the Z-orders of the displays (e.g., first display 1620, the second display 1630, and the third display 1640) are not considered. In an exemplary embodiment, when compared to the arrangement illustrated in FIG. 16B, when the Z-order of the content elements illustrated in FIG. 16C are considered and the Z-order of the display is not considered, the second content 1631 may be displayed above the first content 1621. In contrast, when the Z-order of the display is considered in the arrangement illustrated in FIG. 16C, rather than the Z-order of the content elements, the second content element 1631 may be displayed below the first content element 1621 such that the Z-order of physical display 1620 is considered to be higher than the Z-order of the virtual display associated with the second content element 1631.

As described above, the electronic device 101 may identify the arrangement order of each of the one or more content elements in the Z-direction based on preset regulations and the configured Z-order.

FIG. 16D illustrates a method of displaying each of the one or more content elements according to the Z-order of each of the one or more content elements without consideration of the Z-order of the display and the virtual display.

Referring to FIG. 16D, the Z-orders of the content elements may be ranked such that content element 1650 has the highest Z-order, then content element 1651, then content element 1652, and finally content element 1653, where content element 1653 has the lowest Z-order. In an exemplary embodiment, content element 1650 and content element 1652 are mapped to the virtual display and content element 1651 and content element 1653 are mapped to a physical display.

In this case, the order in which the plurality of elements is displayed on the display is based on a ranking of the Z-orders of the plurality of elements. Similar to FIG. 16C, the Z-orders of the display and the virtual display may not be considered in the arrangement illustrated in FIG. 16D. Accordingly, content element 1650, content element 1651, content element 1652, and content element 1653 may be sequentially displayed.

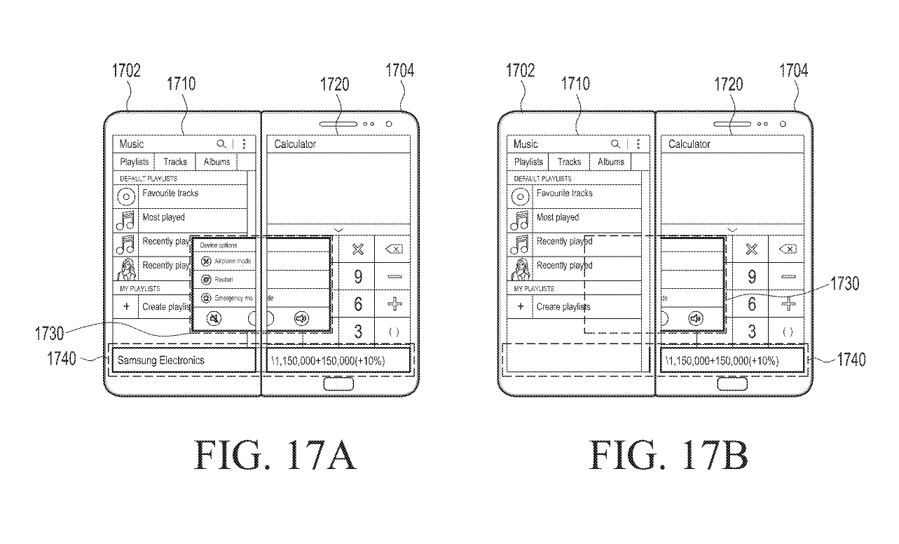

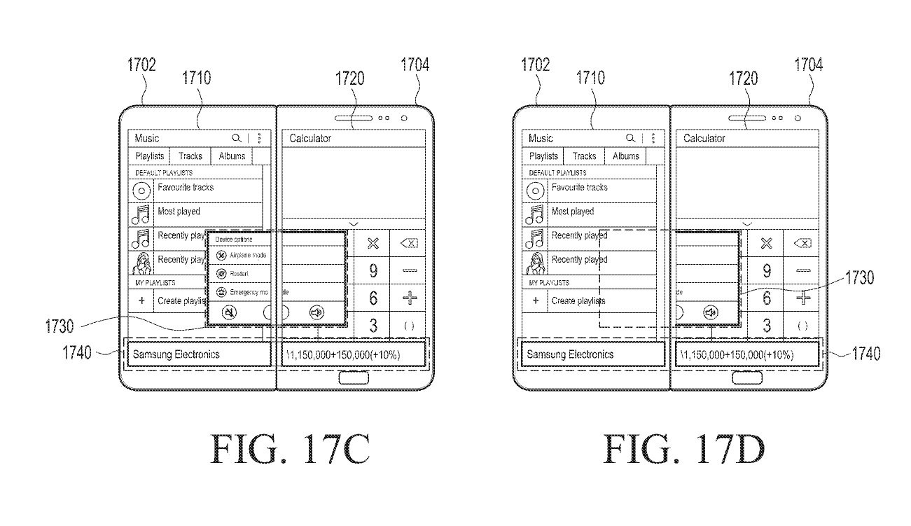

FIGS. 17A, 17B, 17C, and 17D illustrate a method of displaying each of the one or more elements on the display according to the Z-order by the electronic device according to various embodiments of the present disclosure.

FIG. 17A describes a case where arrangement orders of a plurality of content elements 1710, 1720, 1730, and 1740 are identified in the Z-direction according to the Z-order of the display.

Referring to FIG. 17A, the first content element 1710 corresponds to the first display 1702 and the second content element 1720 corresponds to the second display 1704. Further, the third content element 1730 and the fourth content element 1740 correspond to the virtual display.

Referring to FIG. 17A, it is assumed that the Z-order of the virtual display is determined to be higher than the Z-order of the physical displays 1702 and 1704. Accordingly, the third content element 1730 and the fourth content element 1740 corresponding to the virtual display may be displayed to overlap the first content element 1710 and/or the second content element 1720.

In an exemplary embodiment, when the third content element 1730 and the fourth content element 1740 are displayed to overlap the first content element 1710 and a touch input is received in an area associated with the first content element 1710 (e.g., within the first display 1702 outside of an area associated with the third content element 1730 or the fourth content element 1740), the Z-order associated with the first display 1702 may be changed such that the first display 1702 has a higher Z-order than the other content elements 1730, 1740 after the touch input is received.

For example, the Z-order of the first display 1702 corresponding to the area associated with the first content element 1710 in which the touch input is received may become larger than the Z-order of the virtual display (e.g., content elements 1730, 1740). Accordingly, as illustrated in FIG. 17B, the first content element 1710 may be displayed to overlap the portions of third content element 1730 and the fourth content element 1740 associated with the first display 1702.

As described above, when the arrangement orders in the Z-direction are identified according to the Z-order of the display, both the third content element 1730 and the fourth content element 1740 are hidden by the first content element 1710. However, uninterrupted access to the fourth content element 1740 may be desired. In an exemplary embodiment, when the fourth content element 1740 includes content associated with stock information, it may be desired to display the fourth content element 1740 even when a touch input is received in an area associated with the first content element 1710 or a second content element 1720.

FIGS. 17C and 17D describe a case where arrangement orders of the plurality of content elements 1710, 1720, 1730, and 1740 are identified in the Z-direction according to the Z-orders of the content elements.

Referring to FIG. 17C, the first content element 1710 corresponds to the first display 1702 and the second content element 1720 corresponds to the second display 1704. Further, the third content element 1730 and the fourth content element 1740 correspond to the virtual display.

Referring to FIG. 17C, it is assumed that the Z-order of the virtual display is determined to be higher than the Z-order of the physical displays 1702, 1704. Accordingly, the third content element 1730 and the fourth content element 1740 corresponding to the virtual display may be displayed to overlap the first content element 1710 and the second content element 1720.

When a touch input is received in an area associated with the first content element 1710, the Z-order of the first display 1702 may be changed such that the first display 1702 has a higher Z-order than the virtual display (e.g., content elements 1730, 1740). For example, the Z-order of the first content element 1710 associated with the received touch input may become larger than the Z-order of the third content element 1730 and the fourth content element 1740. However, parameters associated with Z-order configuration may be preselected such that a Z-order associated with a content element and/or a display may be defined to be greater than a Z-order of a selected content element and/or display.

In an exemplary embodiment, when the user selects the fourth content element 1740 to remain the highest Z-order, when a first touch input corresponding to the first content element 1710 is received the Z-order of the first content element 1710 is increased but may not become greater than the Z-order of the fourth content element 1740 even though the touch input associated with the first content element 1710 is received. Accordingly, as illustrated in FIG. 17D, the first content element 1710 is displayed above the third content element 1730 and below the fourth content element 1740. As described above, when the arrangement orders in the Z-direction are identified according to the Z-order configured according to each of the plurality of content elements, the plurality of content elements may be more adaptively displayed.

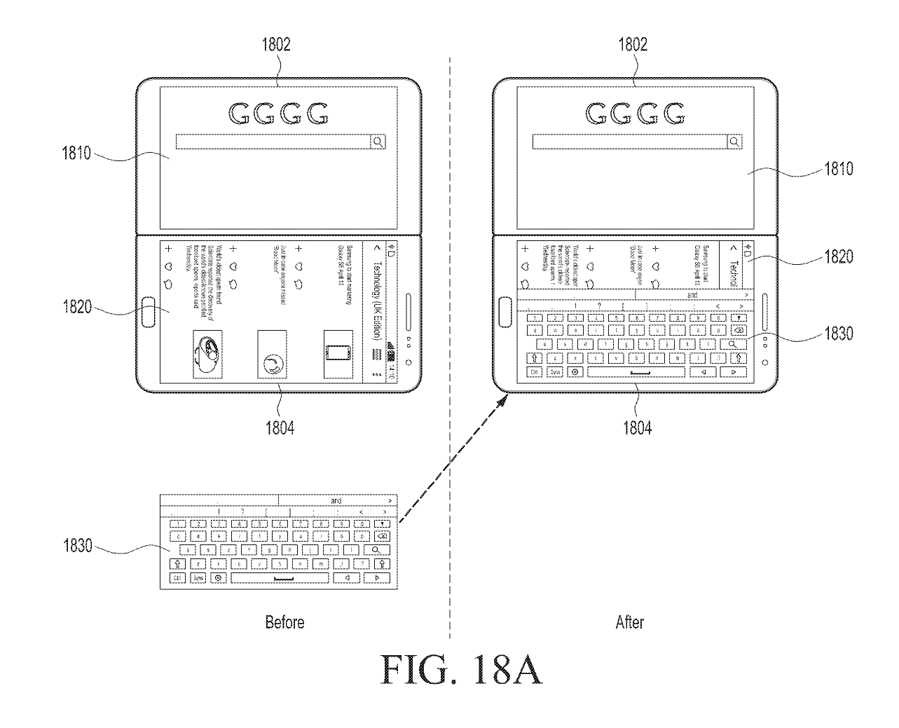

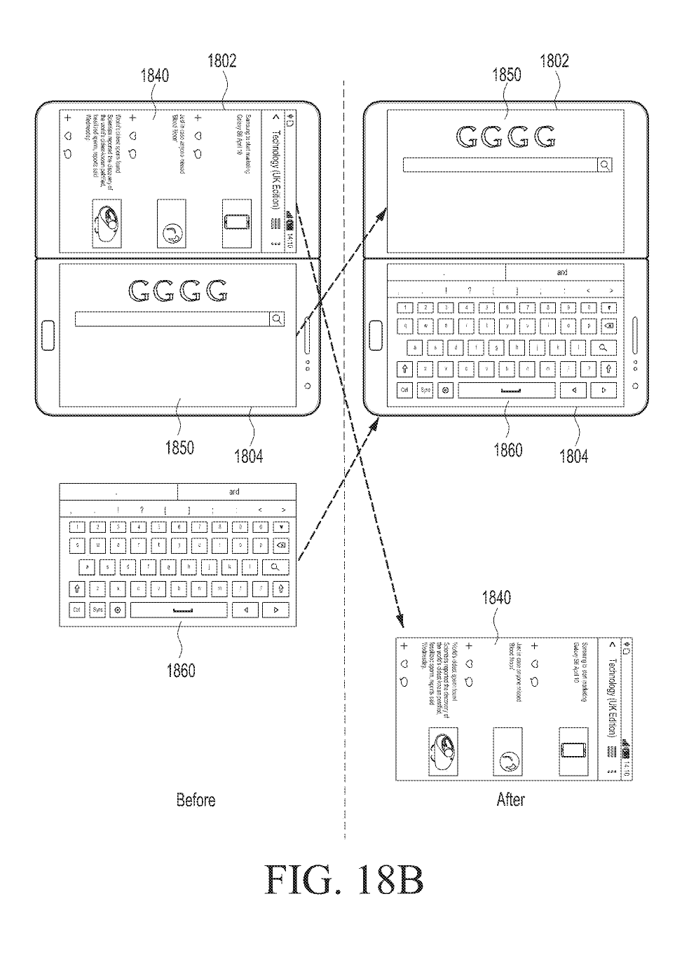

FIGS. 18A and 18B illustrate mapping between the virtual display and the physical display by the electronic device according to various embodiments of the present disclosure.

FIG. 18A describes a case where the electronic device 101 maps a preset virtual display to a null display. When the electronic device 101 maps the virtual display to the null display, the electronic device 101 may maintain a state where there is no physical display mapped to the virtual display although the content element corresponding to the virtual display exists. Accordingly, the electronic device 101 may create an effect of hiding not only the virtual display but also the content element corresponding to the virtual display. Further, the electronic device 101 may rapidly display the virtual display by switching between the null display and the physical display.

As illustrated in FIG. 18A, a first content element 1810 displayed on the first display 1802 may be orientated in a direction different from the second content element 1820 displayed on the second display 1804. For example, the first content element 1810 includes a text input unit where the top left corner of the first content element 1810 is displayed in a lower left corner of the first display 1802) and the second content element 1820 includes content oriented such that a top left corner of the content is displayed in a top left corner of the second display 1804. As described above, when the orientation of the second display 1804 is changed, layouts of all content elements corresponding to the second display 1804 should be controlled. When the content elements corresponding to the second display 1804 do not provide a layout associated with the changed orientation, the entire content element may not be displayed on the second display 1804 where a portion of the content element may not be displayed on the second display 1804. For example, certain operating systems, such as ANDROID OS may only support one particular orientation according to the content element such that re-orientation of the content element is prevented or does not include the entire content element.

When the electronic device 101 according to various embodiments of the present disclosure displays the text input unit to input text into the first content element 1810 displayed on the first display 1802, the electronic device 101 may change mapping information of the third content element 1830 indicating the text input unit mapped to the null display into mapping information indicating the mapping to the second display 1804. As described above, by dynamically changing the mapping information such that the virtual display corresponding to the third content element 1830, which has been mapped to the null display, is mapped to the second display 1804 without changing the orientation of the content element 1820 displayed on the second display 1804, the electronic device 101 may display the third content element 1830 on the second display 1804 while maintaining the layout of the third content element 1830.

FIG. 18B illustrates a method of changing a correspondence relation between contents corresponding to the physical display and the virtual display by the electronic device 101.

Referring to FIG. 18B, in order to input text into a second content element 1850 displayed on the second display 1804, the electronic device 101 may display a third content element 1860 corresponding to a text input unit on one of the first display 1802 and the second display 1804. However, when the third content element 1860 is displayed on the second display 1804, at least a portion of the second content element 1850 is hidden, so it may be difficult to identify whether the text is properly input. Further, when the third content element 1860 is displayed on the first display 1802, a text input window may be located below the text input unit.

Accordingly, displaying the second content element 1850 on the first display 1802 and displaying the third content element 1860 on the second display 1804 may be a method of further improving the usability.

In an exemplary embodiment, the orientation of each display may be changed during a process of changing the display displaying the content element. Accordingly, the layout of the content element corresponding to each display should be re-configured, and the content elements may not be normally displayed according to a result of the re-configuration. Further, since the layout of the content element should be re-configured according to the orientation of the display and the re-configured layout of the content element should be displayed through each display, a response speed of the user may be reduced and power consumption may increase.

In another exemplary embodiment, as illustrated in FIG. 18B, by changing only the correspondence relation between the first content element 1840, the second content element 1850, and the third content element 1860 corresponding to the first display 1802, the second display 1804, and the virtual display, respectively, the electronic device 101 according to various embodiments of the present disclosure may display the second content element 1850 on the first display 1802 and the third content element 1860 on the second display 1804. Accordingly, a separate change in the orientation of the display is not required, and thus the layout of each of the content elements does not need to be re-configured and abnormal displaying of each of the content elements according to the re-configuration of the layout may not be made.

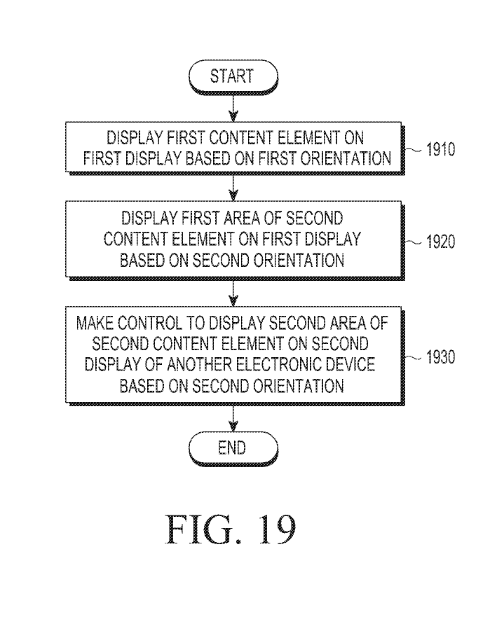

FIG. 19 is a flowchart illustrating a content display method by the electronic device according to various embodiments of the present disclosure.

Referring to FIG. 19, in operation 1910, the electronic device 101 may display the first content element on the first display of the electronic device 101 based on a first orientation. The first content element may be a content element corresponding to the first display and may be displayed in the first orientation of the first display.

In operation 1920, the electronic device 101 may display a first area of the second content element on the first display based on a second orientation. The second content element may be a content element corresponding to a preset virtual display, and the first area of the second content element may be displayed based on the second orientation according to orientation information of the virtual display on the first display.

In operation 1930, the electronic device 101 may be configured to display a second area of the second content element on the second display of another electronic device based on the second orientation. The other electronic device 102 or 104 may construct a multi-display system with the electronic device 101, and the electronic device 102 or 104 and the electronic device 101 may use each other's displays as a multi-display.

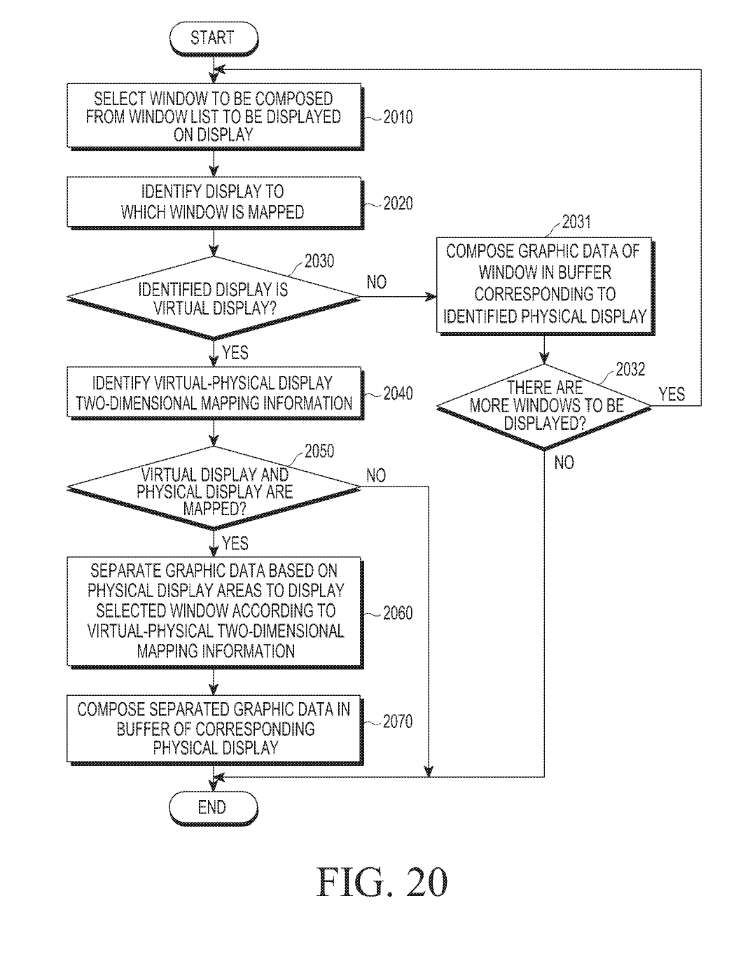

FIG. 20 is a flowchart illustrating a content display method by the electronic device according to various embodiments of the present disclosure.

Referring to FIG. 20, in operation 2010, the electronic device 101 may select a content element such as a window to be composed from a window list to be displayed on the display. The electronic device 101 may select the window to be composed according to a received user input and configuration information of an operating system and an executed application.

In operation 2020, the electronic device 101 may identify the display to which the selected window is mapped.

In operation 2030, the electronic device 101 may identify whether the identified display is the virtual display. When the identified display is not the virtual display, the electronic device 101 may compose graphic data associated with the window in a buffer corresponding to the identified physical display in operation 2031. Accordingly, the electronic device 101 may display the selected window on the display 160.

In operation 2032, the electronic device 101 may identify whether there are more windows to be displayed on the electronic device 101. The electronic device 101 returns to operation 2010 when there are windows to be displayed, and end the process when there is no window to be displayed.

When the identified display is the virtual display, the electronic device 101 may identify virtual-physical display two-dimensional mapping information indicating mapping information between the virtual display and the physical display in operation 2040.

In operation 2050, the electronic device 101 may identify whether the virtual display and the physical display are mapped based on the virtual-physical display two-dimensional mapping information. When the virtual display and the physical display are not mapped, the electronic device 101 may end the process.

When the virtual display and the physical display are mapped, the electronic device 101 may separate the graphic data of the window based on physical display areas to display the selected window according to the virtual-physical two-dimensional mapping information in operation 2060. A detailed method of separating the graphic data of the window is the same as that described in FIGS. 9 and 10.

In operation 2070, the electronic device 101 may compose the separated graphic data of the window in the buffer of the corresponding physical display. Accordingly, the electronic device 101 may display the selected window on the display 160.

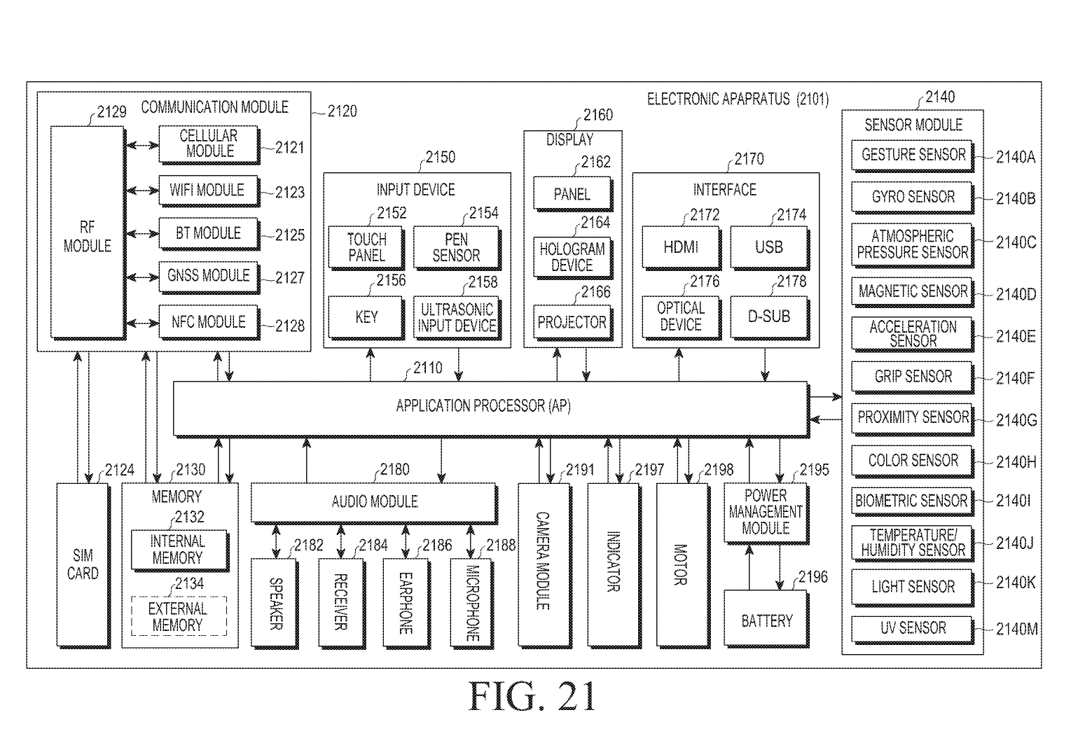

FIG. 21 is a block diagram of an electronic device according to various embodiments of the present disclosure.

Referring to FIG. 21, an electronic device 2101 may include, for example, all or some of the electronic device 101 illustrated in FIG. 1. The electronic device 2101 may include one or more APs 2110, a communication module 2120, a subscriber identification module (SIM) 2124, a memory 2130, a sensor module 2140, an input device 2150, a display 2160, an interface 2170, an audio module 2180, a camera module 2191, a power management module 2195, a battery 2196, an indicator 2197, and a motor 2198.

The processor 2110 may control a plurality of hardware or software components connected to the processor 2110 by driving an operating system or an application program and perform various types of data processing and calculations. The processor 2110 may be implemented by, for example, a system on chip (SoC). According to an embodiment of the present disclosure, the processor 2110 may further include a GPU and/or an image signal processor. The processor 2110 may include at least some of the components (for example, a cellular module 2121) illustrated in FIG. 21. The processor 2110 may load commands or data received from at least one of the other components (for example, a non-volatile memory) in a volatile memory, process the loaded commands or data, and may store various types of data in a non-volatile memory.

The communication module 2120 may have a configuration equal or similar to that of the communication interface 170 of FIG. 1. The communication module 2120 may include, for example, a cellular module 2121, a Wi-Fi module 2123, a Bluetooth module 2125, a GNSS module 2127 (for example, a GPS module, a GLONASS module, a BeiDou module, or a Galileo module), an NFC module 2128, and a radio frequency (RF) module 2129.

The cellular module 2121 may provide a voice call, an image call, a text message service, or an Internet service through, for example, a communication network. According to an embodiment of the present disclosure, the cellular module 2121 may distinguish between and authenticate electronic device 2101 within a communication network using a SIM (for example, the SIM card 2124). According to an embodiment of the present disclosure, the cellular module 2121 may perform at least some of the functions which can be provided by the processor 2110. According to an embodiment of the present disclosure, the cellular module 2121 may include a CP.

For example, each of the Wi-Fi module 2123, the Bluetooth module 2125, the GNSS module 2127, and the NFC module 2128 may include a processor for processing data transmitted/received through the corresponding module. According to various embodiments of the present disclosure, at least some (two or more) of the cellular module 2121, the Wi-Fi module 2123, the Bluetooth module 2125, the GNSS module 2127, and the NFC module 2128 may be included in one integrated chip (IC) or IC package.

The RF module 2129 may transmit/receive, for example, a communication signal (for example, an RF signal). The RF module 2129 may include, for example, a transceiver, a power amp module (PAM), a frequency filter, a low noise amplifier (LNA), or an antenna. According to an embodiment of the present disclosure, at least one of the cellular module 2121, the Wi-Fi module 2123, the Bluetooth module 2125, the GNSS module 2127, and the NFC module 2128 may transmit/receive an RF signal through a separate RF module.

The SIM card 2124 may include a card including a SIM and/or an embedded SIM, and contain unique identification information (for example, an IC card identifier (ICCID)) or subscriber information (for example, an international mobile subscriber identity (IMSI)).

The memory 2130 (for example, the memory 130) may include, for example, an internal memory 2132 or an external memory 2134. The internal memory 2132 may include at least one of, for example, a volatile memory (for example, a dynamic random access memory (DRAM), a static RANI (SRAM), a synchronous DRAM (SDRAM), and the like) and a non-volatile memory (for example, a one time programmable read only memory (OTPROM), a PROM, an erasable and programmable ROM (EPROM), an electrically erasable and programmable ROM (EEPROM), a flash memory (for example, a NAND flash memory or a NOR flash memory), a hard drive, or a solid state drive (SSD).

The external memory 2134 may further include a flash drive, for example, a compact flash (CF), a secure digital (SD), a micro-SD, a mini-SD, an extreme digital (xD), a memory stick, or the like. The external memory 2134 may be functionally and/or physically connected to the electronic device 2101 through various interfaces.

The sensor module 2140 may measure a physical quantity or detect an operation state of the electronic device 2101, and may convert the measured or detected information into an electrical signal. The sensor module 2140 may include, for example, at least one of a gesture sensor 2140A, a gyro sensor 2140B, an atmospheric pressure sensor 2140C, a magnetic sensor 2140D, an acceleration sensor 2140E, a grip sensor 2140F, a proximity sensor 2140G, a color sensor 2140H (for example, a red, green, blue (RGB) sensor), a biometric sensor 2140I, a temperature/humidity sensor 2140J, a light sensor 2140K, and an ultraviolet (UV) sensor 2140M. Additionally or alternatively, the sensor module 2140 may include an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 2140 may further include a control circuit for controlling one or more sensors included therein. In some embodiments, the electronic device 2101 may further include a processor configured to control the sensor module 2140 as a part of or separately from the processor 2110, and may control the sensor module 2140 while the AP 2110 is in a sleep state.

The input device 2150 may include, for example, a touch panel 2152, a (digital) pen sensor 2154, a key 2156, or an ultrasonic input device 2158. The touch panel 2152 may use at least one of, for example, a capacitive type, a resistive type, an infrared type, and an ultrasonic type. Further, the touch panel 2152 may further include a control circuit. The touch panel 2152 may further include a tactile layer and provide a tactile reaction to the user.

The (digital) pen sensor 2154 may include, for example, a recognition sheet which is a part of the touch panel or separated from the touch panel. The key 2156 may include, for example, a physical button, an optical key, or a keypad. The ultrasonic input device 2158 may detect ultrasonic waves generated by an input tool through a microphone (for example, a microphone 2188) and identify data corresponding to the detected ultrasonic waves.

The display 2160 (for example, the display 160) may include a panel 2162, a hologram device 2164 or a projector 2166. The panel 2162 may include a configuration identical or similar to that of the display 160 illustrated in FIG. 1. The panel 2162 may be implemented to be, for example, flexible, transparent, or wearable. The panel 2162 may be formed to be a single module with the touch panel 2152. The hologram 2164 may show a three dimensional image in the air by using an interference of light. The projector 2166 may display an image by projecting light onto a screen. The screen may be located, for example, inside or outside the electronic device 2101. According to an embodiment, the display 2160 may further include a control circuit for controlling the panel 2162, the hologram device 2164, or the projector 2166.

The interface 2170 may include, for example, an HDMI 2172, a USB 2174, an optical interface 2176, or a D-subminiature (D-sub) 2178. The interface 2170 may be included in, for example, the communication interface 170 shown in FIG. 1. Additionally or alternatively, the interface 2170 may include, for example, a mobile high-definition link (MHL) interface, an SD card/multi-media card (MMC) interface, or an infrared data association (IrDA) standard interface.

The audio module 2180 may bilaterally convert, for example, a sound and an electrical signal. At least some components of the audio module 2180 may, for example, be included in the input/output interface 150 shown in FIG. 1. The audio module 2180 may process sound information which is input or output through, for example, a speaker 2182, a receiver 2184, earphones 2186, the microphone 2188 or the like.

The camera module 2191 is a device which may photograph a still image and a dynamic image. According to an embodiment of the present disclosure, the camera module 2191 may include one or more image sensors (for example, a front sensor or a back sensor), a lens, an image signal processor (ISP) or a flash (for example, LED or xenon lamp).

The power management module 2195 may manage, for example, power of the electronic device 2101. According to an embodiment, the power management module 2195 may include a power management IC (PMIC), a charger IC, or a battery or fuel gauge. The PMIC may have a wired and/or wireless charging scheme. A magnetic resonance scheme, a magnetic induction scheme, or an electromagnetic scheme may be exemplified as the wireless charging method, and an additional circuit for wireless charging, such as a coil loop circuit, a resonance circuit, a rectifier circuit, and the like may be added. The battery gauge may measure, for example, a residual quantity of the battery 2196, and a voltage, a current, or a temperature during the charging. The battery 2196 may include, for example, a rechargeable battery or a solar battery.

The indicator 2197 may display a predetermined state of the electronic device 2101 or a part of the electronic device 2101 (for example, the processor 2110), such as a boot-up state, a message state, a charging state, or the like. The motor 2198 may convert an electrical signal into mechanical vibrations, and may generate a vibration or haptic effect. Although not illustrated, the electronic device 2101 may include a processing unit (for example, a GPU) for supporting mobile TV. The processing unit for supporting mobile TV may, for example, process media data according to a certain standard such as digital multimedia broadcasting (DMB), digital video broadcasting (DVB), or MEDIAFLO.

Each of the above-described component elements of hardware according to the present disclosure may be configured with one or more components, and the names of the corresponding component elements may vary based on the type of electronic device. The electronic device according to various embodiments of the present disclosure may include at least one of the aforementioned elements. Some elements may be omitted or other additional elements may be further included in the electronic device. Also, some of the hardware components according to various embodiments of the present disclosure may be combined into one entity, which may perform functions identical to those of the relevant components before the combination.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an application-specific IC (ASIC) chip, a field-programmable gate arrays (FPGA), and a programmable-logic device for performing operations which has been known or are to be developed hereinafter.

According to various embodiments of the present disclosure, at least some of the devices (for example, modules or functions thereof) or the method (for example, operations) according to the present disclosure may be implemented by a command stored in a computer-readable storage medium in a programming module form. The instruction, when executed by a processor (e.g., the processor 120), may cause the one or more processors to execute the function corresponding to the instruction. The computer-readable storage medium may be, for example, the storage unit 130.

The computer readable recoding medium may include a hard disk, a floppy disk, magnetic media (e.g., a magnetic tape), optical media (e.g., a compact disc ROM (CD-ROM) and a DVD), magneto-optical media (e.g., a floptical disk), a hardware device (e.g., a ROM, a RAM, a flash memory), and the like. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa.

The programming module according to the present disclosure may include one or more of the aforementioned components or may further include other additional components, or some of the aforementioned components may be omitted. Operations executed by a module, a programming module, or other component elements according to various embodiments of the present disclosure may be executed sequentially, in parallel, repeatedly, or in a heuristic manner. Further, some operations may be executed according to another order or may be omitted, or other operations may be added.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of displaying content elements by an electronic device, the method comprising:
identifying a first content element corresponding to a preset virtual display among one or more content elements to be displayed on a display of the electronic device; and
displaying a first portion of the first content element on the display based on orientation information of the virtual display on the display.

2. The method of claim 1, further comprising configuring the virtual display by configuring state information of the virtual display.

3. The method of claim 2, further comprising transmitting the state information of the virtual display to another electronic device connected to the electronic device to construct a multi-display system.

4. The method of claim 2, wherein the state information of the virtual display includes at least one of a size, orientation information, and a density of the virtual display.

5. The method of claim 1, wherein the identifying of the first content element comprises identifying the first content element based on at least one of an input received at the display, content display configuration information of an operating system, and content display configuration information of an application.

6. The method of claim 1, wherein the displaying of the first portion of the first content element on the display comprises displaying the first portion of the first content element on the display by using mapping information between the display and the virtual display.

7. The method of claim 6, wherein the displaying of the first portion of the first content element on the display comprises:
identifying a first area of the virtual display mapped to the display by using the mapping information; and
identifying the first portion of the first content element corresponding to the first area of the virtual display.

8. The method of claim 1, further comprising:
when state information of the virtual display is updated based on at least one of a received input, content display configuration information of an operating system, and content display configuration information of an application, updating the orientation information and mapping information between the display and the virtual display.

9. The method of claim 1, wherein the displaying of the first portion of the first content element on the display comprises:
rotating the first portion of the first content element in accordance with the orientation information of the virtual display on the display; and
displaying the rotated first portion of the first content element on the display.

10. The method of claim 1, further comprising converting coordinate information of a first touch input received in accordance with the orientation information of the virtual display on the display, wherein the first touch input corresponds to the virtual display.

11. The method of claim 10, further comprising:
receiving information indicating that a second touch input corresponding to a second portion of the first content element is received, from another electronic device displaying the second portion of the first content element; and
when the information is received within a preset time after the first touch input is received, recognizing the first touch input and the second touch input as a multi-touch input.

12. The method of claim 1, further comprising:
identifying a Z-order of each of the one or more content elements; and
displaying each of the one or more content elements on the display based on the identified Z-order.

13. An electronic device comprising:
a display configured to display one or more content elements; and
a processor configured to:
identify a first content element corresponding to a preset virtual display among the one or more content elements to be displayed on a display, and
display a first portion of the first content element on the display based on orientation information of the virtual display on the display.

14. The electronic device of claim 13, wherein the processor is further configured to configure state information of the virtual display.

15. The electronic device of claim 14, further comprising:
a communication module configured to transmit the state information of the virtual display to another electronic device connected to the electronic device to construct a multi-display system.

16. The electronic device of claim 14, wherein the state information of the virtual display includes at least one of a size, orientation information, and a density of the virtual display.

17. The electronic device of claim 13, wherein the processor is further configured to identify the first content element based on at least one of a received input, content display configuration information of an operating system, and content display configuration information of an application.

18. The electronic device of claim 13, wherein the processor is further configured to display the first portion of the first content element on the display by using mapping information between the display and the virtual display.

19. The electronic device of claim 18, wherein the processor identifies a first area of the virtual display mapped to the display by using the mapping information and identifies the first portion of the first content element corresponding to the first area of the virtual display.

20. The electronic device of claim 13, wherein, when state information of the virtual display is updated based on at least one of a received input, content display configuration information of an operating system, and content display configuration information of an application, the processor is further configured to update the orientation information and mapping information between the display and the virtual display.

21. The electronic device of claim 13, wherein the processor is further configured to:
rotate the first portion of the first content element in accordance with the orientation information of the virtual display on the display, and display the rotated first portion of the first content element on the display.

22. The electronic device of claim 13,
wherein the processor is further configured to convert coordinate information of a first touch input received in accordance with the orientation information of the virtual display on the display, and
wherein the first touch input corresponds to the virtual display.

23. The electronic device of claim 22, wherein the processor is further configured to:
receive information indicating that a second touch input corresponding to a second portion of the first content element is received, from another electronic device displaying the second portion of the first content element, and,
when the information is received within a preset time after the first touch input is received, recognize the first touch input and the second touch input as a multi-touch input.

24. The electronic device of claim 13, wherein the processor identifies a Z-order of each of the one or more content elements and displays each of the one or more content elements on the display based on the identified Z-order.

25. An electronic device comprising:
a first display configured to display a first content element based on a first orientation; and
a processor configured to:
display a first area of a second content element on the first display based on a second orientation, and
display a second area of the second content element on a second display of another electronic device connected to the electronic device to configure a multi-display based on the second orientation,
wherein the second display displays a third content element based on a third orientation.

26. The electronic device of claim 25, wherein the processor is further configured to display the first area and the second area based on the second orientation by using orientation information of the virtual display corresponding to the second content element.
